(19) United States
(12) Patent Application Publication
(10) Pub. No.: US 2026/0227303 A1
(43) Pub. Date: Aug. 6, 2026

(54) SYSTEMS AND METHODS FOR MEASURING PARTICLE SIZE IN TISSUE AND TURBID MEDIA

(71) Applicant: The General Hospital Corporation, Boston, MA (US)

(72) Inventors: Zeinab Hajjarian-Kashany, Boston, MA (US); Seemantini Nadkarni, Boston, MA (US)

(21) Appl. No.: 19/150,900

(22) PCT Filed: Jan. 29, 2024
(86) PCT No.: PCT/US2024/013377

§ 371 Date: Jul. 24, 2025

Related U.S. Application Data
(60) Provisional application No. 63/481,988, filed on Jan. 27, 2023.

(51) Int. Cl. G01N 15/0205

(52) U.S. Cl. CPC G01N 15/0211; G01N 2015/0222

(57) ABSTRACT

A system for determining a size of a particle in a sample includes a light source, a camera, and a processor. The processor can be configured to extract polarization-dependent attributes of a speckle pattern that correlate to optical properties of the particle, subject the polarization-dependent attributes to a function to determine the size of the particle, and generate a report indicating the size of the particle in the sample.

### CROSS-REFERENCES TO RELATED APPLICATIONS

The present application is based on, claims priority to, and incorporates herein by reference in its entirety for all purposed, U.S. Provisional Patent Application No. 63/481,988, filed on Jan. 27, 2023.

### STATEMENT REGARDING FEDERALLY SPONSORED RESEARCH

This invention was made with government support under award numbers 2017S001867, 2017D009627, and 2019A006310 from the Air Force Office of Scientific Research. The government has certain rights in the invention.

### BACKGROUND

Particle sizing for the characterization of biofluids, soft tissues, and therapeutic reagents is encountered in multiple applications in biomedical research, clinical medicine, and drug development.

For example, monitoring platelet aggregation provides a firsthand assessment of platelet function, because the aggregate size entails the sum effect of individual hemostasis collectively. As such, particle sizing technologies that afford to quantify platelet aggregation at the point of care (POC) can be invaluable for diagnosing bleeding disorders and monitoring anti-platelet therapies.

Particle sizing capabilities are also critical for characterizing proteins, peptides, DNA strands, and their fragments and aggregates. Moreover, formulating lipid-based drug nano-carriers often involves characterizing the size distribution of nanomaterials such as liposomes, lipid nanoparticles (LNPs), polymers, hydrogels, micelles, gene vectors, and viruses.

In another example, cytological analysis of biological fluids is essentially measuring the size distribution and concentration of various cellular populations. For instance, complete blood count or CBC is one of the most commonly ordered clinical lab tests done as part of a routine physical examination, which entails the assessment of red blood cells (RBCs), or breakdown of RBCs such as hemolysis, platelets, and white blood cells (WBCs). The currently available hematology analyzers exploit principles of flow cytometry to sort out the blood cells. The typical radii of RBCs and platelets range between 3 μm and 4.5 μm, and between 1 μm and 2 μm, respectively. On the other hand, WBCs refer to various cell types, including Neutrophils (6-7 μm), Monocytes (7.5-15 μm), Eosinophils (6-7.5 μm), Lymphocytes (3-9 μm), and Basophils (6-7.5 μm). Each of the WBCs serves a different function.

For example, the Neutrophils comprise 62% of the total WBC population and are responsible for fighting bacteria and fungi. Lymphocytes account for 30% of WBCs and entail B-lymphocytes, which produce and release antibodies to fight infections, T-lymphocytes, which identify and eliminate infected cells and tumor cells, as well as Phagocytes, and natural killer cells, which attack and remove virus-infected and tumor cells. Monocytes present 5.3% of WBCs and migrate from the bloodstream into tissue-resident macrophages. Eosinophils comprise 2.3% of WBC population and are responsible for removing larger parasites and modulating the inflammatory response. Finally, Basophils present less than 1% of WBCs and are known to release histamine for inflammatory responses.

Aside from manual counting in a chamber under a microscope, the primary methods for automated CBC entail a coulter counting and flow cytometry. Both techniques are based on measuring the individual cells flowing through the measuring region based on the electrical impedance (the so-called Coulter principle) or the laser scattering principle, respectively. Both approaches are disadvantaged in that they require flowing the diluted blood through expensive, complex hardware, and are susceptible to flow jams. In yet another example, grading malignant tumor cells is in part based on eyeballing the size distribution of cells and their nuclei in the stained slides of tissue. Histologic grade is one of the most important microscopic features used to predict the prognosis. Tumor grade is often assessed in a semi-numeric scoring method, by assessing tubule formation (scored 1 to 3), nuclear pleomorphism (i.e., having enlarged nuclei with wide size distribution scored 1 to 3), and presence of mitotic figures (scored 1 to 3). Another example includes particle size analysis of lipid particles, including LDL cholesterol size for detecting lipid disorders in patients. Therefore, the capability to assess the size distribution of particles in fresh tissue, in its native sate would be invaluable to the diagnosis pipeline. Therefore, there is a need for particle sizing approaches that enables CBC measurements in whole blood in a simple and affordable manner.

### SUMMARY

The present disclosure provides systems and methods that overcome the drawbacks of traditional attempts to determine particle size in tissue and turbid media.

In some aspects, the present disclosure provides a system for determining a size of a particle in a sample. The system can include a light source, a camera, and a processor. The light source can be configured to illuminate the sample with light. The camera can be configured to acquire backscattered light from the sample to form a speckle pattern. The processor can be configured to extract polarization-dependent attributes of the speckle pattern that correlate to the size of the particles, and to a secondary degree, the optical properties of a medium of the sample, subject the polarization-dependent attributes to a function to determine the size of the particle, and generate a report indicating the size of the particle in the sample.

In some aspects, the present disclosure provides a method for determining the size of scattering particles in a sample. The method can include illuminating the sample with a light, capturing backscattered light from the sample to form a speckle pattern, and analyzing the speckle pattern to determine attributes that include at least one of a ratio of intensities along the short and long axis of intensity envelope in the parallel polarization state, a measure of the circularity of the intensity envelope in the orthogonal polarization state, and/or a measure of decorrelation rate ratio of parallel and orthogonal polarization states. A fourth attribute that may be obtained by calculating the radial extent of the diffuse reflectance profile or the intensity envelope of back-scattered speckle or light in the orthogonal or perpendicular polarization state.

The method can further include applying the attributes to a model to determine an absorption coefficient or reduced absorption coefficient as well as a cluster centroid which then leads to the selection of a size prediction model, and estimating the size of the scattering particles based on the cluster centroid and the extracted attributes.

Alternatively, the step regarding the estimation of optical properties, such as for instance absorption and reduced scattering coefficients may be skipped all together by employing all four attributes, instead of only three, to directly identify the closest cluster and the corresponding regression model, and in turn, the particle size, without going through the intermediate step of estimating and extracting the optical properties, such as for instance absorption and reduced scattering coefficients.

In some aspects, the present disclosure provides a system for determining a size of scattering particles in a sample. The system can include a light source, a sample stage, at least one camera, and a processing unit. The light source can be configured to emit a polarized light beam. The polarization can be linear, circular, or even elliptical. The sample stage can position the sample in the path of the polarized light beam. At least one camera can be positioned to capture backscattered light from the sample and form a speckle pattern. The processing unit can be configured to analyze polarization-dependent attributes of the captured speckle pattern to extract a set of attributes from the speckle pattern that include at least one of a ratio of intensities along the short and long axis of intensity envelope in the parallel polarization state, a measure of the circularity of the intensity envelope in the cross or orthogonal polarization state, and/or a measure of the radial extent of the intensity envelope in the cross or orthogonal polarization state and/or a measure of decorrelation rate ratio of parallel and orthogonal polarization states. A fourth attribute may be obtained by calculating the radial extent of the diffuse reflectance profile or the intensity envelope of back-scattered speckle or light in the orthogonal or perpendicular polarization state.

The processing unit can be configured to additionally apply the attributes to a model to determine an absorption coefficient or a reduced absorption coefficient, use the absorption coefficient or reduced absorption coefficient to determine a centroid coordinates and a size prediction model, and estimate the size of the scattering particles based on the cluster centroid and the extracted attributes. Alternatively, the attributes may be applied to calculate the Euclidean distance of their coordinates from the cluster centroids, and identify the closest cluster centroid, which then leads to the selection of size prediction model, and estimating the size of the scattering particles based on the cluster centroid and the extracted attributes. In this respect, advantageously, by employing all four attributes a person skilled in the art may circumvent the intermediate step of estimating the optical properties, and directly measure the size in a sample of arbitrary and unknown optical properties, such as reduced scattering and absorption coefficients.

In some aspects, the present disclosure provides a method for determining the size of scattering particles in a sample. The method can include illuminating the sample with a polarized light and capturing backscattered light from the sample to form a speckle pattern. The method can further include analyzing the speckle pattern to determine attributes that include at least one of a ratio of intensities along the long and short axes of intensity envelope at the parallel polarization state, a circularity of the intensity envelope at orthogonal polarization states, a decorrelation rate ratio of speckle intensity modulations at parallel and orthogonal polarization states, or a radial extent of the intensity envelope at orthogonal polarization states. The method can further include applying the attributes to a clustering approach that assigns a four-tupled attribute vector to one of five clusters. The method can further include estimating the size of the scattering particles based on a regression model of the cluster, without the need to estimate or know the optical properties.

### BRIEF DESCRIPTION OF THE DRAWINGS

The invention will be better understood and features, aspects, and advantages other than those set forth above will become apparent when consideration is given to the following detailed description thereof. Such detailed description makes reference to the following drawings.

FIG. 1 is a schematic illustration of an exemplary optical laser setup.

FIG. 2 is a schematic illustration of another exemplary optical laser setup.

FIG. 3 is a schematic illustration of another exemplary optical laser setup.

FIG. 4A is an intensity plot for determining a first attribute of a speckle pattern of a sample.

FIG. 4B is an intensity plot for determining a second attribute of a speckle pattern of the sample.

FIG. 4C is a plot for determining a third attribute of the sample.

FIG. 5A is a parallel diffuse reflectance profile for particles with radii 50 nm.

FIG. 5B is a parallel diffuse reflectance profile for particles with radii 200 nm.

FIG. 5C is a parallel diffuse reflectance profile for particles with radii 500 nm.

FIG. 5D is a parallel diffuse reflectance profile for particles radii 2000 nm.

FIG. 5E is a perpendicular diffuse reflectance profile for particles radii 50 nm.

FIG. 5F is a perpendicular diffuse reflectance profile for particles radii 200 nm.

FIG. 5G is a perpendicular diffuse reflectance profile for particles with radii 500 nm.

FIG. 5H is a perpendicular diffuse reflectance profile for particles with radii 2000 nm.

FIG. 5I is a g2(t) curve for particles with radii 50 nm.

FIG. 5J is a g2(t) curve for particles with radii 200 nm.

FIG. 5K is a g2(t) curve for particles with radii 500 nm.

FIG. 5L is a g2(t) curve for particles with radii 2000 nm.

FIG. 6A is graph of a first particle attribute versus particle radius, color-coded according to the reduced scattering coefficient.

FIG. 6B is a graph of a second particle attribute versus the particle radius, color-coded according to the reduced scattering coefficient.

FIG. 6C is a graph of a third particle attribute versus the particle radius, color-coded according to the reduced scattering coefficient.

FIG. 7A is a plot of a first particle attribute versus particle radius, assuming that the reduced scattering coefficient is 1 mm−1 and the absorption coefficient is zero.

FIG. 7B is a plot of a second particle attribute versus particle radius, assuming that the reduced scattering coefficient is 1 mm−1 and the absorption coefficient is zero.

FIG. 7C is a plot of a third particle attribute versus particle radius, assuming that the reduced scattering coefficient is 1 mm−1 and the absorption coefficient is zero.

FIG. 7D is a clustering of the first, second, and third particle attributes.

FIG. 7E is a violin plot of cluster assignments.

FIG. 7F is a step-wise regression model of the particle attributes.

FIG. 8A is a speckle frame series obtained at parallel polarization states with respect to illumination.

FIG. 8B is a speckle frame series obtained at perpendicular polarization states with respect to illumination.

FIG. 8C is a temporal averaging of the speckle series of FIG. 8A and graphically depicts the approach taken for calculation of the first attribute, X1.

FIG. 8D is a temporal averaging of the speckle series of FIG. 8B and graphically depicts the approach taken for calculation of the second attribute, X2.

FIG. 8E is a total diffuse reflectance profile. It also graphically depicts the approach taken for deducing the optical properties, such as the reduced scattering coefficient from the total diffuse reflectance profile or the intensity envelope.

FIG. 8F is a temporally resolved analysis of the speckle frame series.

FIG. 8G is a graphical calculation of a third attribute.

FIG. 8H represents the input of first, second, and third attributes into a model.

FIG. 9A includes photographic representations of particle images.

FIG. 9B is a diffuse reflectance profile in a parallel orientation.

FIG. 9C is a diffuse reflectance profile in a perpendicular orientation.

FIG. 9D is a scatter diagram of the particles of FIG. 9A,

FIG. 9E is an application of a model.

FIG. 10A is a stained histology section of normal adipose tissue.

FIG. 10B is a parallel polarized diffuse reflectance profile for the normal adipose tissue.

FIG. 10C is a perpendicularly polarized diffuse reflectance profile for the normal adipose tissue.

FIG. 10D is plot for determining a third attribute of the normal adipose tissue.

FIG. 10E is a stained histology section of a plainly homogenous benign fibrous V

FIG. 10N is a first diffuse reflectance profile for the grade 3 carcinoma specimen.

FIG. 10O is a second diffuse reflectance profile for the grade 3 carcinoma specimen.

FIG. 10P is plot for determining a third attribute of the grade 3 carcinoma specimen.

FIG. 11A is a stained histology section of breast tissue.

FIG. 11B is an estimated particle size in an invasive ductal carcinoma that is surrounded by and is invading adipose tissue.

FIG. 12A is a parallel-polarized diffuse reflectance profile/intensity envelope for calculating the first attribute of a whole blood sample.

FIG. 12B is a cross-polarized diffuse reflectance profile/intensity envelope for calculating the second attribute of the whole blood sample.

FIG. 12C entails the plots of temporal speckle autocorrelation functions of parallel and perpendicularly polarized speckle for the whole blood sample.

FIG. 12D is a plot for determining a third attribute of the whole blood sample.

FIG. 12E is a parallel-polarized diffuse reflectance profile/intensity envelope for calculating the first attribute of a lysed blood sample.

FIG. 12F is a perpendicularly-polarized diffuse reflectance profile/intensity envelope for calculating the second attribute of the lysed blood sample.

FIG. 12G entails the plots of temporal speckle autocorrelation functions of parallel and perpendicularly polarized speckle for the lysed blood sample.

FIG. 12H is a plot for determining a third attribute of the lysed blood sample.

FIG. 12I is a parallel-polarized diffuse reflectance profile/intensity envelope for calculating the first attribute of a lysed blood sample with a platelet agonist.

FIG. 12J is a cross-polarized diffuse reflectance profile/intensity envelope for calculating the second attribute of the lysed blood sample with the platelet agonist.

FIG. 12K entails the plots of temporal speckle autocorrelation functions of parallel and perpendicularly polarized speckle for the lysed blood sample with the platelet agonist.

FIG. 12L is a plot for determining a third attribute of the lysed blood sample with the platelet agonist.

FIG. 12M is a parallel-polarized diffuse reflectance profile/intensity envelope for calculating the first attribute of a lysed blood sample with a platelet agonist and an anti-platelet agent.

FIG. 12N is a cross-polarized diffuse reflectance profile/intensity envelope for calculating the second attribute of the lysed blood sample with the platelet agonist and the anti-platelet agent.

FIG. 12O entails the plots of temporal speckle autocorrelation functions of parallel and perpendicularly polarized speckle for the lysed blood sample with the platelet agonist and the anti-platelet agent.

FIG. 12P is a plot for determining a third attribute of the lysed blood sample with the platelet agonist and the anti-platelet agent.

FIG. 13A is a parallel-polarized diffuse reflectance profile/intensity envelope for calculating the first attribute of a whole blood sample.

FIG. 13B is a cross-polarized diffuse reflectance profile/intensity envelope for calculating the second attribute of a whole blood sample.

FIG. 13C is the first attribute as a function of time.

FIG. 13D is the second attribute as a function of time.

FIG. 14 is a schematic illustration of a system for evaluating local particle size, speckle patterns, and first, second, and third attributes of a sample.

FIG. 15A is a co-polarized speckle frame series of a mono-dispersed polystyrene microsphere phantom.

FIG. 15B is a cross-polarized speckle frame series of the mono-dispersed polystyrene microsphere phantom.

FIG. 15C is a temporal average of the series of FIG. 15A and highlights the calculation of the first attribute X1.

FIG. 15D is a temporal average of the series of FIG. 15B and highlights the calculation of the second and forth attributes, X2 and X4.

FIG. 15E is a differential decorrelation rate of the series of FIGS. 15A and 15B and highlights the calculation of the third attribute, X3.

FIG. 15F is a vector assigned to a cluster based on a Euclidean distance.

FIG. 16A is a volume plot for a first particle attribute.

FIG. 16B is a volume plot for a second particle attribute.

FIG. 16C is a volume plot for a third particle attribute.

FIG. 16D is a volume plot for a fourth particle attribute.

FIG. 16E is a cross-section volume plot for the first particle attribute.

FIG. 16F is a cross-section volume plot for the second particle attribute.

FIG. 16G is a cross-section volume plot for the third particle attribute.

FIG. 16H is a cross-section volume plot for the fourth particle attribute.

FIG. 16I is a clustering analysis for the various particle attributes.

FIG. 16J is a scatter plot for the various particle attributes.

FIG. 17A is a plot of a first attribute of an aqueous glycerol suspension of polystyrene microspheres with a radius of 75 nm.

FIG. 17B is a plot of a first attribute of an aqueous glycerol suspension of polystyrene microspheres with a radius of 100 nm.

FIG. 17C is a plot of a first attribute of an aqueous glycerol suspension of polystyrene microspheres with a radius of 250 nm.

FIG. 17D is a plot of a first attribute of an aqueous glycerol suspension of polystyrene microspheres with a radius of 5000 nm.

FIG. 17E is a plot of a second attribute of the aqueous glycerol suspension of polystyrene microspheres with the radius of 75 nm.

FIG. 17F is a plot of a second attribute of the aqueous glycerol suspension of polystyrene microspheres with the radius of 100 nm.

FIG. 17G is a plot of a second attribute of the aqueous glycerol suspension of polystyrene microspheres with the radius of 250 nm.

FIG. 17H is a plot of a second attribute of the aqueous glycerol suspension of polystyrene microspheres with the radius of 5000 nm.

FIG. 17I is a ratio of speckle decorrelation for calculating a third attribute for the aqueous glycerol suspension of polystyrene microspheres with the radius of 75 nm.

FIG. 17J is a ratio of speckle decorrelation for calculating a third attribute for the aqueous glycerol suspension of polystyrene microspheres with the radius of 100 nm.

FIG. 17K is a ratio of speckle decorrelation for calculating a third attribute for the aqueous glycerol suspension of polystyrene microspheres with the radius of 250 nm.

FIG. 17L is a ratio of speckle decorrelation for calculating a third attribute for the aqueous glycerol suspension of polystyrene microspheres with the radius of 5000 nm.

FIG. 17M is a scatter diagram.

FIG. 18A is a plot of a first attribute of a lipid droplet in non-fat milk.

FIG. 18B is a plot of a first attribute of a lipid droplet in low-fat (1%) milk.

FIG. 18C is a plot of a first attribute of a lipid droplet in reduced-fat (2%) milk.

FIG. 18D is a plot of a first attribute of a lipid droplet in whole (4%) milk.

FIG. 18E is a plot of a second attribute of the lipid droplet in non-fat milk.

FIG. 18F is a plot of a second attribute of the lipid droplet in low-fat (1%) milk.

FIG. 18G is a plot of a second attribute of the lipid droplet in reduced-fat (2%) milk.

FIG. 18H is a plot of a second attribute of the lipid droplet in whole (4%) milk.

FIG. 18I is a ratio of speckle decorrelation for calculating a third attribute for the lipid droplet in non-fat milk.

FIG. 18J is a ratio of speckle decorrelation for calculating a third attribute for the lipid droplet in low-fat (1%) milk.

FIG. 18K is a ratio of speckle decorrelation for calculating a third attribute for the lipid droplet in reduced-fat (2%) milk.

FIG. 18L is a ratio of speckle decorrelation for calculating a third attribute for the lipid droplet in whole (4%) milk.

FIG. 18M is a scatter diagram.

FIG. 19 shows blood specimens spiked with varying concentrations of saline solutions.

FIG. 20A is a plot of a first attribute of a whole blood sample sample spiked with a saline solution of 2% NaCl concentration.

FIG. 20B is a plot of a first attribute of a whole blood sample spiked with a saline solution of 5% NaCl concentration.

FIG. 20C is a plot of a first attribute of a whole blood sample spiked with a saline solution of 7% NaCl concentration.

FIG. 20D is a plot of a first attribute of a whole blood sample spiked with a saline solution of 10% NaCl concentration.

FIG. 20E is a plot of a second attribute of the whole blood sample spiked with the saline solution of 2% NaCl concentration.

FIG. 20F is a plot of a second attribute of the whole blood sample spiked with the saline solution of 5% NaCl concentration.

FIG. 20G is a plot of a second attribute of the whole blood sample spiked with the saline solution of 7% NaCl concentration.

FIG. 20H is a plot of a second attribute of the whole blood sample spiked with the saline solution of 10% NaCl concentration.

FIG. 20I is ratio of speckle decorrelation for calculating a third attribute for the whole blood sample spiked with the saline solution of 2% NaCl concentration.

FIG. 20J is ratio of speckle decorrelation for calculating a third attribute for the whole blood sample spiked with the saline solution of 5% NaCl concentration.

FIG. 20K is ratio of speckle decorrelation for calculating a third attribute for the whole blood sample spiked with the saline solution of 7% NaCl concentration.

FIG. 20L is ratio of speckle decorrelation for calculating a third attribute for the whole blood sample spiked with the saline solution of 10% NaCl concentration.

FIG. 20M is a scatter plot.

FIG. 21A is a photograph displaying the gross pathology of normal fibroadipose breast tissue.

FIG. 21B is a histology section of fibrous and adipose regions of the breast tissue.

FIG. 21C is a view of collagen fibrils of the breast tissue.

FIG. 21D is a spatial map of the breast tissue.

FIG. 21E is a spatial map displaying a first attribute.

FIG. 21F is a spatial map displaying a second attribute.

FIG. 21G is a spatial map displaying a third attribute.

FIG. 21H is a spatial map displaying a fourth attribute.

FIG. 22A is a photograph displaying the gross pathology of human breast carcinoma tissue.

FIG. 22B is a histology section of the carcinoma tissue.

FIG. 22C is a view of collagen fibrils of the carcinoma tissue.

FIG. 22D is a spatial map of the carcinoma tissue.

FIG. 22E is a spatial map displaying a first attribute.

FIG. 22F is a spatial map displaying a second attribute.

FIG. 22G is a spatial map displaying a third attribute.

FIG. 22H is a spatial map displaying a fourth attribute.

FIG. 23 illustrates an exemplary workflow development of a model that can be used to predict the scattering of particle size from polarization-dependent attributes of laser speckle images.

FIG. 24 is a schematic diagram of a system for determining particle characteristics.

FIG. 25 is a flow chart of a method for determining the size of particles in a sample.

### DETAILED DESCRIPTION

The following discussion is presented to enable a person skilled in the art to make and use examples of the disclosed technology. Various modifications to the illustrated examples will be readily apparent to those skilled in the art, and the generic principles herein can be applied to other examples and applications without departing from the disclosed technology. Thus, examples of the disclosed technology are not intended to be limited to examples shown, but are to be accorded the widest scope consistent with the principles and features disclosed herein. The following detailed description is to be read with reference to the figures. The figures, which are not necessarily to scale, depict selected examples and are not intended to limit the scope of examples of the disclosed technology. Skilled artisans will recognize the examples provided herein have many useful alternatives and fall within the scope of disclosed technology.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items. The use of “about” or “approximately” and variations thereof herein is meant to refer to variation in the numerical quantity that may occur, for example, through the measuring of pressures or temperatures within various portions of a valve assembly that may include embodiments of the disclosure herein; through inadvertent error in these procedures; through differences in the accuracy or precision of various components used to carry out the methods; and the like. Throughout the disclosure, the terms “about” and “approximately” are intended to refer to a range of values ±10% of the numeric value that the term proceeds, inclusive.

Particle sizing and characterization of biomaterials and tissues is useful across diverse industrial and clinical domains. The nm-μm range granularity exhibited by biomaterials and tissues encompasses a spectrum of endogenous particle sizes. Current methodologies fall short in assessing particle size distribution in intact, untampered biomaterials and tissues in their native state. In general, particle size characterization poses a widespread challenge across scientific disciplines, including pharmaceutical research, food processing, and diagnostic pathology. In pharmaceuticals, sizing nanodrug carriers like liposomes and micelles, a crucial aspect of formulation, involves decomposing the drug bolus into its essential components. Similarly, in the food industry, invasive techniques are used for sizing lipid droplets during processes like homogenization and fat reduction, through titrating dairy products in solvents for accurate sizing purposes. Embodiments of the present disclosure can address these and other drawbacks to particle sizing and characterization. Furthermore, embodiments of the present disclosure can provide systems and methods for measuring an average size of scattering particles in a medium.

Principles of light scattering by particles may be exploited to enable simple and elegant approaches for non-invasive, optical characterization of samples in multiple applications in biomedical research clinical medicine, and pharmaceutical developments. It also opens new opportunities for quality control of products in food sciences, cosmetic industries, and polymer production. In recent years, optical particle sizing technologies such as Static Light scattering (SLS), also known as laser diffraction (LD), as well as Dynamic light scattering (DLS), have experienced significant advancements and have developed into the gold standard techniques for various applications, based on the range of the sizes offered by these technologies. For instance, DLS has proved its utility in the sub-micron range, whereas LD is frequently operated at much larger size scales of up to a few mm.

In DLS, the particles of interest are dispersed and diluted in extremely low concentrations in a suspension of known viscosity. A laser beam is used to illuminate the sample and the fluctuations of the scattered light are analyzed by a digital correlator to evaluate the intensity autocorrelation of the back-scattered light according to:

$${g}_{2} ( t ) = \frac{〈 I ( t ) I ( 0 ) 〉}{{〈 I ( t ) 〉}^{2}} = {e}^{- \frac{1}{3} {q}^{2} 〈 Δ {r}^{2} ( t ) 〉} \qquad ( 1 )$$

### Where

$$q = \frac{4 π}{λ} sin ( θ / 2 )$$

is the momentum transfer, θ is the scattering angle, λ is the wavelength of the laser, and [symbol] Δr²(t) [symbol] is the mean square displacement of the scattering particles.

From the intensity autocorrelation function, the mean square displacement of the particle's Brownian motion is deduced, from which the diffusion coefficients of particles, D, is extracted according to:

$$〈 Δ {r}^{2} ( t ) 〉 = 6 D t \qquad ( 2 )$$

Subsequently, assuming that the viscosity of the solvent is known, the average hydrodynamic radius of the particles are measured using the Stokes-Einstein equation as follows:

$$a = \frac{{K}_{B} T}{6 π D η} \qquad ( 3 )$$

While DLS is a useful approach to determine the size distribution of many nano- and biomaterials systems, it presents many disadvantages. For example, DLS is a low-resolution method, and the polydispersity index needs to be less than 0.1. In addition, the presence of large particles in the population could overshadow the smaller particles and adversely affect the accuracy of measurements. Moreover, in DLS the particles need to be dispersed in extremely low concentrations in a solvent of known, low viscosity, which prohibits its applicability to characterizing most biofluids and tissues.

While DLS is limited to the particle sizing in the range of a few microns, static light scattering (SLS), also known as laser diffraction (LD), has emerged as the prevalent standard for measuring particles from hundreds of nm to a few mms. Like DLS, in LD a laser beam illuminates a dilute suspension of particles, and the scattered light at various angles is detected by a number of detectors. LD is based on the principle that the smaller particles diffract the light at larger angles, where is the refraction from larger particles is mostly forwardly directed. Therefore, by measuring the angular dependence of scattering, and exploiting the principles of either Mie or Fraunhofer scattering theories, the particle size may be extracted. In addition to the main red laser beam (typical wavelength of 632 nm), LD often entails another laser source of a shorter wavelength (known as the blue source), which is scattered in the forward direction from even the smaller particles in the population to enable covering the smaller size ranges. Nevertheless, LD approach poses several limitations, as enumerated below. Firstly, the refractive indices of the particles and the surrounding dispersant need to be known beforehand, which can be problematic for new or composite materials. Even if both refractive indices are known, there is no guarantee that the particle size could be evaluated as the laser diffraction models often exist only for a pre-defined set of refractive index values.

Moreover, LD frequently assumes that the particles are perfect spheres, and that the specimen is homogenously exhibiting a uniform refractive index. For particles of large eccentricity, the LD approach frequently results in under-estimated particle size values. In addition, more complex algorithms are needed to back out the particle size distribution in polydisperse samples, in which large and small particles coexist. Finally, since Mie scattering and Fraunhofer diffraction theories account only for the single scattering of light from particles, LD may not be used for particle sizing in concentrated samples of arbitrary optical properties, such as most biological fluids and soft tissues. This is because of rich scattering in opaque tissue, the superposition of multiple scattering events results in a broader scattering angle distribution, which leads to an underestimation of the particle size. As such, despite its broad dynamic range and rapid measurements, the commercially available LD devices are complex, bulky, and costly, due to the complexities involved in the photodetector arrays and laser sources. In addition, the device requires frequent calibration and maintenance and exhibits a long learning curve, which reduces the enthusiasm for its operation in biomedical, clinical, and industrial applications.

Here, we present a new particle sizing platform based on the polarization attributes of laser speckle, which affords particle sizing in highly optically scattering samples including biological fluids and soft tissues (e.g., native tissue). Speckle is a granular intensity pattern that forms when a coherent beam of light is scattered off opaque, turbid media, such as biological tissue. When a coherent, and linearly polarized beam of light is incident on the sample, photons travel within the tissue and scatter off the tissue particles multiple times before emerging back to the surface. The photon trajectories in the medium are governed by the size and concentrations of particles as well as the refractive index mismatch between the particles and their surrounding medium. Collectively, these parameters determine the optical properties, namely absorption coefficient, μa, scattering coefficient, μs, and the scattering asymmetry parameter, g, i. e. the ratio of the forwardly scattered light to that of back-scattered light. From these, the reduced scattering coefficient μs′ is defined as μs (1-g). The path length distribution further depends on the polarization state of the light rays. More specifically, for a sample of small particles, the back-scattered speckle is mostly composed of short, non-diffuse paths, which favor parallel polarization. On the other hand, for larger particles, the scattering is mostly forwardly directed, and the back-scattered light is composed mostly of paths with lengths S~1*=1/μs′ that exhibit equal probability of parallel and perpendicular polarization. Therefore, if the incident beam is polarized, the component of the back-scattered speckle that exhibits parallel and perpendicular polarization states with respect to the incident beam exhibit specific attributes that could inform the scattering particle size.

We have previously observed that because of the differences in the path length distribution, the temporally averaged speckle frame series in the parallel-polarized channel, i.e. the parallel-polarized component of the diffuse reflectance profile, DRP∥, grows from a bi-lobular pattern for smaller particles to a clover-like shape or a Quadro-folium pattern for larger particles, by growing a pair of horizontal lobes. In addition, the relative rate of speckle fluctuations in perpendicular and parallel polarization states, as quantified by the temporal intensity autocorrelation function g2L(t) and g2∥(t) exhibits particle size dependence, reduced by the growth of the particle size. Nevertheless, both above-mentioned trends seem to additionally depend on the optical properties and may not uniquely inform the particle size. Moreover, each of these trends exhibits significant dependencies on the particle size over a specific range and their variation with the size is diminished beyond this range. For instance, DRP∥ significantly varies in the a=125 nm-6 μm range. However, the variation for a<125 nm is subtle. In addition, the differential decay rate of g2L(t) and g2∥(t) is significant for a≤500 nm, but the two curves nearly overlap for a>500 nm.

Embodiments of the disclosure provide system for expanding the measurement range for particle sizing to 10 nm-6 μm, by identifying comprehensive polarization-dependent attributes of the laser speckle, perform an exhaustive analysis to isolate their dependencies on the optical properties, and clustering these attributes within a consolidated prediction model that permits deducing the accurate particle size. The detailed methods are presented below.

The purpose of the proposed model is to permit prediction and estimation of the particle size, from the polarization-dependent attributes of the laser speckle. The challenge here is that each of the individual attributes alone may only be used to infer the particle size over a limited range. In addition, they each are dependent not only on the particle size, but also on the optical properties of the specimen. Therefore, our goal here is to better understand the trends of dependencies of the polarization-dependent attributes on the particle size, a, and the optical properties across different ranges of particle size. For this, we take a statistical approach and create an exhaustive set of observations. This will enable building a convergent universal model that inherently only includes the most significant attributes at each range while accounting for variation in optical properties to infer the particle size.

For this purpose, we first develop a polarization-sensitive correlation-transfer Monte-Carlo (PSCT-MCRT) ray-tracing algorithm that enables simulating both the statics and dynamics of the speckle patterns in various polarization states and to create an exhaustive set of polarization-dependent attributes as a function of the particle size and optical properties.

Subsequently, a multiple regression model is developed that permits predicting the particle size from both the optical properties and the polarization-dependent attributes.

For this purpose, PSCT-MCRT simulations will be executed for a large set of a and μs′ values. In addition, additional simulations were executed by varying a and μs′ and μa.

From the trajectories of the returning photons, the static and dynamic variations of the speckle patterns at each polarization state are reconstructed. These include (a) Parallel-polarized component of the diffuse reflectance profile, DRP∥. (b) Perpendicularly-polarized component of the diffuse reflectance profile, DRP⊥. (c) Speckle intensity autocorrelation function in parallel and perpendicular polarization states: g2⊥(t) and g2∥(t),

From these, 3 distinct attributes are extracted as follows. The first attribute, X1, is extracted from DRPII and is the ratio of the intensity along the horizontal axis to that of the vertical axis. This parameter is calculated by contorting the DRPII at 30% of the maximum intensity and identifying the inner and outer circles of the contour. The value of the intensity between these two circles is plotted as a function of the angle and the ratio is calculated as the X1 parameter.

The second attribute, X2, is the circularity of DRP⊥. This value is obtained by contouring the DRP⊥ at the 30% intensity level of the maximum and calculating the ratio of the 4πA/P2, where A is the area and P is the perimeter of the contour. The more lobulated the pattern, the lower the circularity. This parameter is often maximized for very large and very small particles and hits its minima when the g parameter is maximized, independently of μs′ value.

The third attribute, X3, is the ratio of the log ratio of the g2(t) curves, i.e. log (g2⊥(t))/log (g2∥(t)).

For each given μs′, K-means clustering is used to cluster the particles, based on their X1, X2, and X3 to small and large groups. For each group, a regression model is developed that predicts a from X1, X2, and X3.

The process is repeated for all μs′ values and the models are consolidated into a single one, that expresses the particle size, as a function of X1, X2, and X3, and μs′.

From the μs′ the coordinates for centroids of the clusters are determined. The cluster to which the particles belong is determined based on the proximity of the point with the coordinate (X1, X2, X3). That is the particles are assigned to the cluster, which its centroid that had the shortest Euclidean distance to (X1,X2,X3).

Based on the above steps, the following model equations are obtained that connects particle radius, a, with X1, X2, X3:

$$Cluster Small : \hat{a} = 423 - 225 {X}_{3} Cluster Large : \{ \begin{matrix}{μ}_{s}^{′} \leq 1 & log ( \hat{a} ) = 0.64 + 3.14 {X}_{1} \\ 1 < {μ}_{s}^{′} \leq 2 & log ( \hat{a} ) = - 0.89 {μ}_{s}^{′} + 1.78 + ( 1.86 + {μ}_{s}^{′} ) {X}_{1} \\ 2 \leq {μ}_{s}^{′} & log ( \hat{a} ) = - 10 {μ}_{s}^{′} + 23.5 + ( 19 + 10 {μ}_{s}^{′} ) {X}_{1}\end{matrix} \qquad ( 4 )$$

Replacing the X1, X2, X3 and μs′ in the above equation (eqn. 4) yields the estimated particle size.

Testing and validation: We then validate this model in phantom polystyrene bead suspensions. Following validation studies, we demonstrate the utility of this approach for three applications in clinical medicine, namely grading of freshly excised breast carcinoma specimens, platelet function testing in whole blood, and diagnosis of hemolysis.

### Materials and Methods

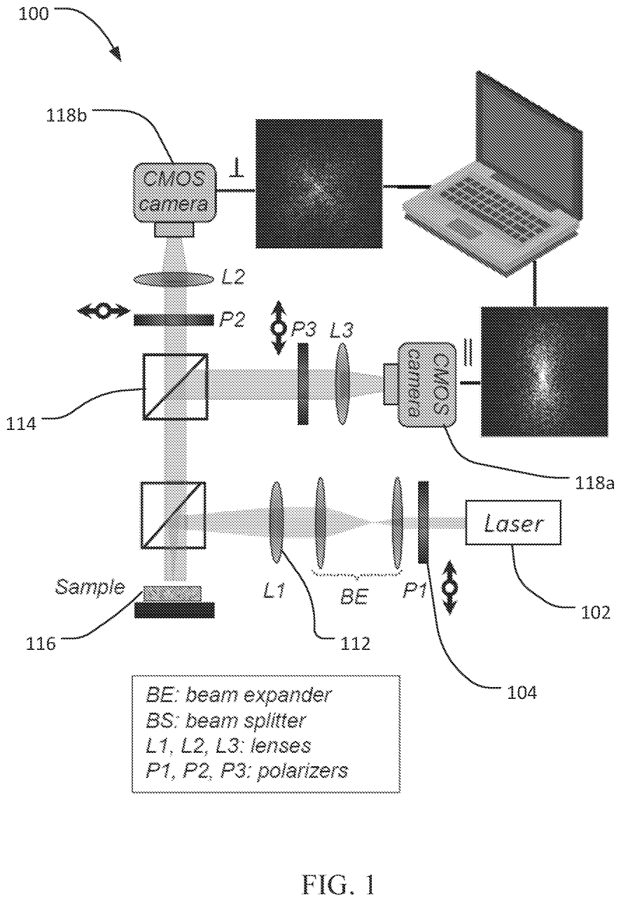

Optical setup: The Laser Speckle particle sizing setup 100 is depicted in FIG. 1. A laser beam 102 (e.g., 633 nm, Helium Neon, 45 mW, JDSU) is passed through a polarizer filter 104 which is typically a linear polarizer in the horizontal direction, but could also exhibit linear vertical, circular clockwise, and circular counter clock-wise polarization status. A polarization modulator could be alternatively used to direct polarized light of at least two different polarization states to the sample.

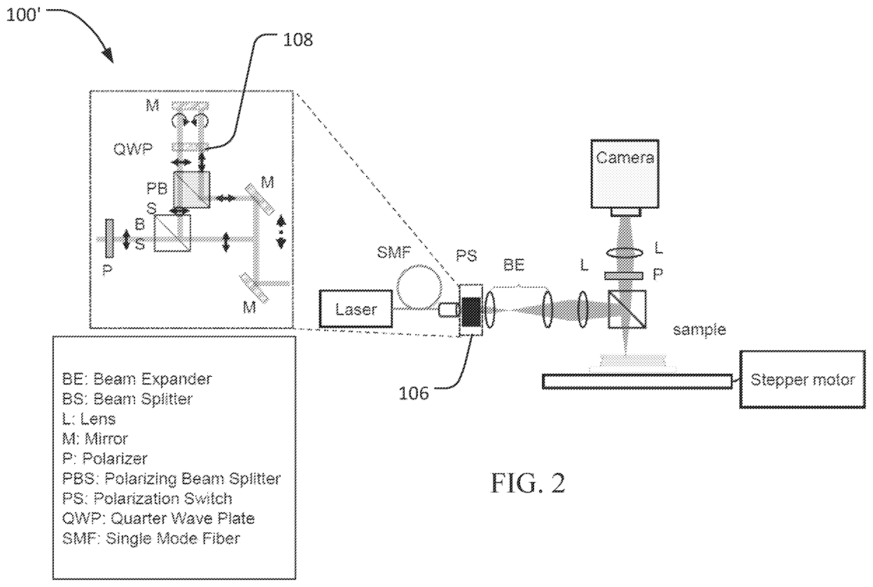

Such a polarization modulator may include a polarized beam splitter 106 and a quarter wave plate 108 and a mirror, as shown in the setup 100′ of FIG. 2. It may also be a commercially available one, based on liquid crystal retarders. Alternatively, it can be realized for instance using computer generated holograms and spatial light modulators. In some examples, a light source for the setup 100 can include more than one singular light source. Still, in other embodiments, the light source does not have to be laser-based and could include incoherent light.

Referring back to FIG. 1, the polarized beam of light was then collimated and bent 90 degrees and focused by a lens 112 and a beam splitter 114 on the surface of the sample 116. The backscattered light rays are collected and split into two different light paths and detected by two different high-speed CMOS cameras 118a, 118b (e.g., Basler, ACa 2000-340 km, Germany). Each camera 118a, 118b collected the back-scattered light after it was passed through a polarization analyzer. While the polarization analyzer in the first camera 118a exhibited the same state as of the illumination polarizer, the polarization analyzer on the second camera 118b exhibited an orthogonal polarization state with respect to the illumination polarization. Alternatively, speckle patterns at two orthogonal polarization states may be captured at two distal sections of the CMOS sensor by directing and focusing light as such.

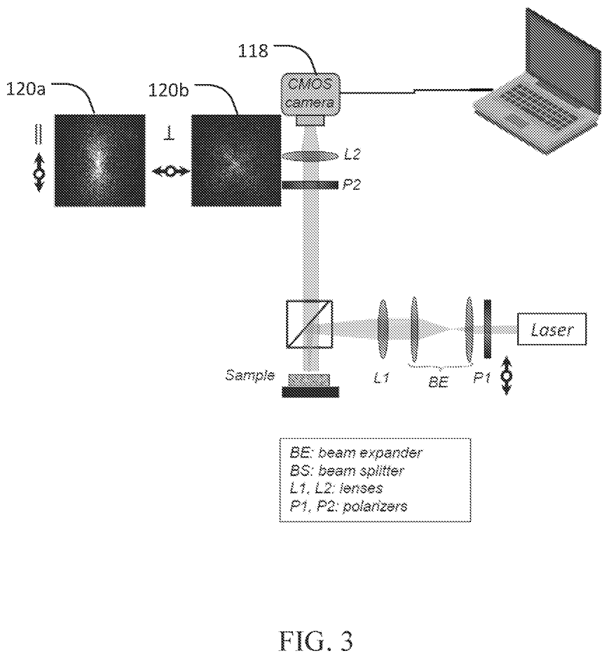

Another strategy is to collect light on the same location on the CMOS 118 sensor by switching between two polarizers at orthogonal polarization states 120a, 120b placed in the detection arm, as displayed in FIG. 3. Speckle frame series were captured at various frame rates commensurate with the dynamics of the evaluated sample to ensure sufficient temporal sampling and high speckle contrast. Algorithms for extracting particles sizes from polarization attributes of speckle patterns are detailed below.

Evaluation of the Polarization-Dependent Attributes from Laser Speckle Patterns

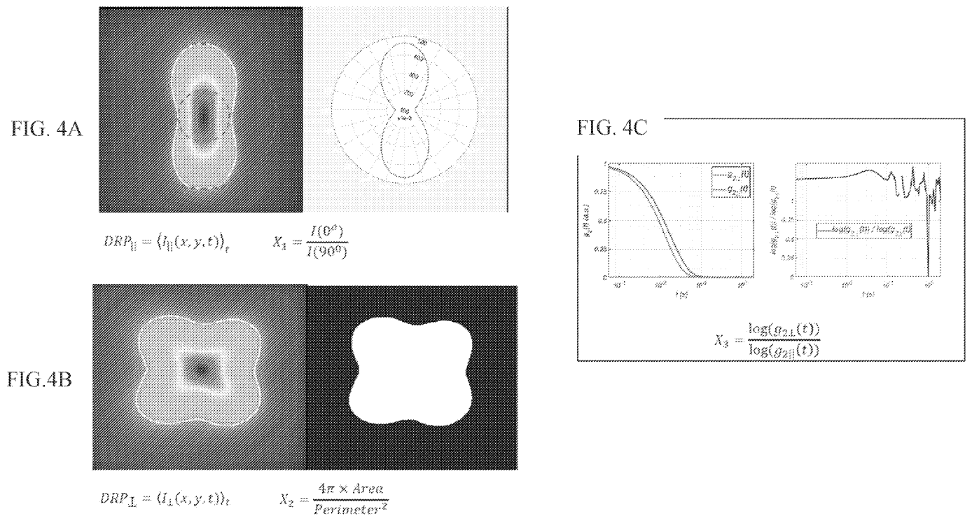

The speckle frame series acquired at parallel and perpendicular linear polarization states (e.g., 120a, 120b of FIG. 3) were processed to obtain the polarization-dependent attributes. For this purpose, parallel and perpendicular polarized speckle patterns were acquired. Next, temporal-averaging of the speckle patterns yield the DRP∥ and DRP⊥. To this end, all the speckle frames within the series are added and the resulting frame is divided by the number of frames within the frame series. From DRP∥ and DRP⊥. which X1, X2, and μs′ are extracted, as displayed in FIGS. 4A and 4B, and explained above for the case of simulated DRP patterns.

X1: Ratio of the parallel-polarized diffuse reflectance, DRP∥, i.e. time-averaged speckle, at 90o to 0o azimuth angles. This parameter is calculated by contorting the DRP∥ at 30% of the maximum intensity and identifying the inner and outer circles of the contour. The value of the intensity between these two circles is plotted as a function of the angle and the ratio is calculated as the X1 parameter.

X2:

$$Circularity = \frac{4 π \times Area}{{Perimeter}^{2}} ,$$

of the perpendicular-polarized diffuse reflectance, DRP⊥. This attribute is obtained by contouring the DRP⊥ at the 30% intensity level of the maximum and calculating the ratio of the 4πA/P2, where A is the area and P is the perimeter of the contour. The more lobulated the pattern, the lower the circularity. This parameter is often maximized for very large and very small particles and hits its minima when the g parameter is maximized, independently of μs′ value.

In addition, temporal cross-correlation analysis of speckle frames provided the g_{2⊥}(t) and g₂∥(t), from which X3 is evaluated as, the ratio of the speckle decorrelation rates of perpendicular and parallel polarizations, X_{FIG.2B}=log (g_{2⊥}(t))/log (g₂∥(t)) (see FIG. 4C).

### Polarization-Sensitive Correlation-Transfer Monte Carlo-Ray Tracing Simulations:

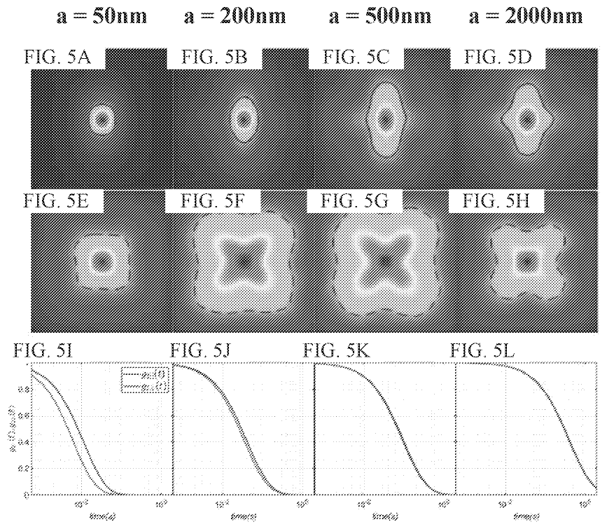

We expanded our previously developed polarization-sensitive correlation-transfer Monte-Carlo Ray tracing approach, to enable simulating both the time-averaged and time-resolved polarization-dependent attributes of the speckle, namely DRP_{∥}, DRP_{⊥}, g_{2⊥}(t), and g_{2∥}(t). (see FIG. 5) Creating this exhaustive set was needed to include as many observations as possible and enable clustering of the particles based on the polarization aspects of laser speckle and the optical properties of the sample as detailed below.

A total of 1 million photons were traced for each variation. The photons then continued traveling in the medium until they encounter the next particle and emerged back at the surface. The PSCT-MCRT algorithm is based on the Mie theory of scattering, which returns the parallel and perpendicular polarized components of the back-scattered light as a function of the incident light using a matrix with diagonal entries of the S1 and S2 parameters as follows.

$$[ \begin{matrix}{E}_{\vert \vert s} \\ {E}_{⊥ s}\end{matrix} ] = \frac{{e}^{j k ( R - z )}}{- jkR} [ \begin{matrix}{S}_{2} ( θ ) & 0 \\ 0 & {S}_{1} ( θ )\end{matrix} ] [ \begin{matrix}{E}_{\vert \vert i} \\ {E}_{⊥ i}\end{matrix} ] \qquad ( 5 )$$

Here, Eᵢ accounts for the incident field and Eₛ represents the scattered electric field, where

$${E}_{i} = {E}_{0} {e}^{- jkz + j ω} \qquad ( 6 )$$

In which the E₀ is the magnitude, k is the wavenumber, z is the traveling direction of the incident beam and ω=2π/λ is the angular frequency. S1 and S2 depending on the size parameter x, or the ratio of the particle size to wavelength, the complex index of refraction of the particle, and the scattering polar angle theta through a series Riccati-Bessel functions, the spherical Bessel functions, and the spherical Henkel functions.

Accordingly, during each scattering event, the direction of the photon changed in azimuthal, φ and polar angles, θ, based on joint probability distribution function of:

$$P ( θ , φ ) = {I}_{0} {S}_{11} ( θ ) + {S}_{12} ( θ ) [ {Q}_{0} cos ( 2 φ ) + {U}_{0} sin ( 2 φ ) ] \qquad ( 7 )$$

Here [I0, Q0, U0, V0] stands for the Stokes vector of the incident photon, which are related to the incident electric field components as follows:

$${S}_{11} = \frac{1}{2} ( {\vert {S}_{2} \vert}^{2} + {\vert {S}_{1} \vert}^{2} ) {S}_{12} = \frac{1}{2} ( {\vert {S}_{2} \vert}^{2} - {\vert {S}_{1} \vert}^{2} ) {S}_{33} = \frac{1}{2} ( {S}_{2}^{*} {S}_{1} + {S}_{2} {S}_{1}^{*} ) {S}_{34} = \frac{1}{2} i ( {S}_{1} {S}_{2}^{*} - {S}_{2} {S}_{1}^{*} ) \qquad ( 8 )$$

In addition, the Stokes vector of the photon is updated using the single scattering function, as follows:

$$[ \begin{matrix}{I}_{S} \\ {Q}_{s} \\ {U}_{s} \\ {V}_{s}\end{matrix} ] = \frac{1}{{k}^{2} {R}^{2}} [ \begin{matrix}{S}_{11} & {S}_{12} & 0 & 0 \\ {S}_{12} & {S}_{22} & 0 & 0 \\ 0 & 0 & {S}_{33} & {S}_{34} \\ 0 & 0 & - {S}_{34} & {S}_{33}\end{matrix} ] R ( φ ) [ \begin{matrix}{I}_{i} \\ {Q}_{i} \\ {U}_{i} \\ {V}_{i}\end{matrix} ] \qquad ( 9 )$$

The distance traveled between the successive scattering events is randomly distributed with an average value of 1/μₜ, where μₜ=μₛ+μₐ, μₛ is the scattering coefficient and μₐ is the absorption coefficient. The PSCT-MCRT algorithm is executed for a matrix of particle size values and reduced scattering coefficients, assuming a fixed index mismatch, but varying particles concentrations. From these simulations, the parallel and perpendicular DRP as well as the g₂(t) curves are extracted for the said matrix of μs′ and a values, as:

$${DRP}_{\vert \vert} = IR + QR \qquad ( 10 )$$

$${DRP}_{⊥} = IR - QR \qquad ( 11 )$$

$${g}_{2 \vert \vert}^{MCRT} ( t ) - 1 = {( {\sum }_{i = 1}^{n} {W}_{i} ( {I}_{i} + {Q}_{i} ) {e}^{- \frac{1}{3} {k}^{2} 〈 Δ {r}^{2} ( t ) 〉 {Y}_{i}} )}^{2} \qquad ( 12 )$$

$${g}_{2 ⊥}^{MCRT} ( t ) - 1 = {( {\sum }_{i = 1}^{n} {W}_{i} ( {I}_{i} - {Q}_{i} ) {e}^{- \frac{1}{3} {k}^{2} 〈 Δ {r}^{2} ( t ) 〉 {Y}_{i}} )}^{02} \qquad ( 13 )$$

Here, IR and QR are the total values of the first two elements of the stokes vectors on the surface, obtained by spatial binning of the stokes vectors of the returning photons. In addition, Ii and Qi are the first two elements of the Stokes vectors of the individual returning photons. Moreover, Wi and Yi are the energy and momentum transfer of the individual returning photons.

The PSCT-MCRT algorithm was executed for a matrix of particle size values a, ranging from 10 nm to 6 μm, and reduced scattering coefficients of μs′ ranging between 0.2 mm⁻¹ to 4 mm⁻¹, in 0.2 mm⁻¹ increments. It was assumed that the refractive index mismatch is fixed, and for a particle of given a, the concentration was modified to achieve a given μₛ′. The absorption was also included in model in a way that for each computer-generated μₛ′, the μₐ was varied to realize a series of μₐ/μₛ′ ranging from 0.05 to 1 in 0.05 increments.

From this exhaustive set of simulation data, we identified multiple polarization-dependent attributes and selected 3 of them for cluster analysis of the particles, for experimentally evaluated attributes, and paralleled here for simulated speckle patterns. The first parameter is extracted from DRP_{II} and is the ratio of the intensity along the horizontal axis to that of the vertical axis. This parameter is calculated by contorting the DRP_{II} at 30% of the maximum intensity and identifying the inner and outer circles of the contour. The value of the intensity between these two circles is plotted as a function of the angle and the ratio is calculated as the X1 parameter (see FIG. 4A).

The next parameter is the circularity of the cross-polarized DRP. This value is obtained by contouring the DRP_{⊥} at the 30% intensity level of the maximum and calculating the ratio of the area to the perimeter squared. The more lobulated the pattern, the lower the circularity. This parameter is often maximized for very large and very small particles and hits its minima when the g parameter is maximized, independently of μs′ value (see FIG. 4B).

Lastly, the ratio of the log of g_{2⊥}(t) to the log of g₂∥(t) is tabulated as the third parameter (see FIG. 4C).

### Clustering Methods:

FIGS. 5A-H display the PSCT-MCRT simulated DRP∥ and DRP⊥ as well as g2|(t) and g2⊥(t), assuming mono-dispersed scattering particles of radii 50 nm, 200 nm, 500 nm, and 2000 nm, assuming a refractive index of 1.59 for the particles and 1.45 for the surrounding medium. The number densities of particles are varied to ensure that for all cases, μₛ′=1 mm⁻¹. We observe that DRP_{∥}, grows from a bi-lobular pattern for smaller particles to a clover-like shape or a Quadro-folium pattern for larger particles, by growing a pair of horizontal lobes. On the other hand, DRP_{⊥} retains a clover-like shape for all sizes, but this pattern exhibits increased circularity for very small and very large particles and a lower circularity for particles that are in the mid-range and have radii that nearly match the wavelength of the laser beam. In addition, the relative rate of speckle fluctuations in perpendicular and parallel polarization states, as quantified by the temporal intensity autocorrelation function g_{2⊥}(t) and g_{2∥}(t) exhibits particle size dependence and reduces by the growth of the particle size.

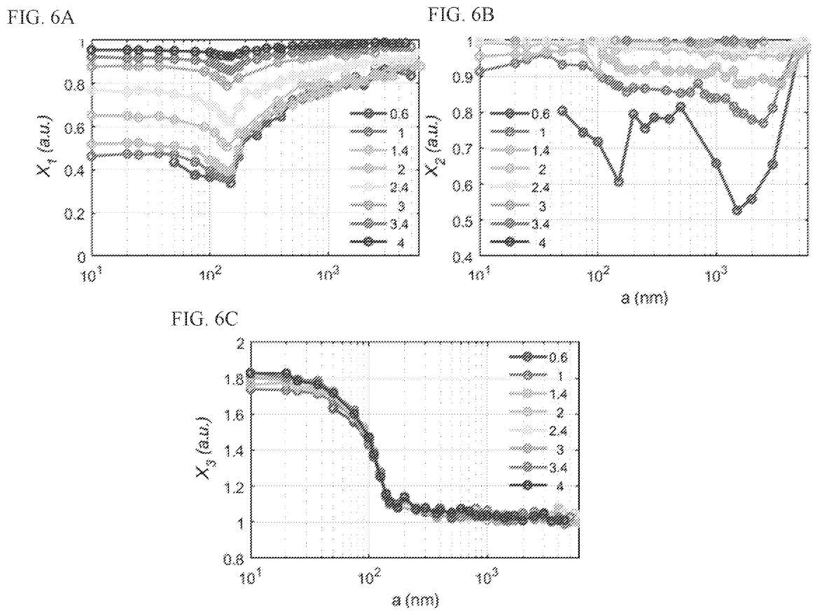

FIGS. 6A-C show the X1, X2, and X3 attributes as a function of a and μₛ′. We can see that all these parameters exhibit variations both with particle size and μₛ′. In other words, while X1 increases with the growth of the particle size for sizes 125 nm and above, the rate of this increases is strongly dependent on μs′. On the other hand while X2 exhibits a U shape trend with a, reaching a minima for mid-range particle sizes, the location of this minima and its depth depends on the μₛ′. Lastly, while X3 quickly reduced as the particle size increases in sub-micron range for a given a, X3 increases with μₛ′. These observations highlight the fact that the knowledge of μₛ′ is required for estimating the scattering particle size. Fortunately, we have previously demonstrated that the μₛ′ may be extracted from the temporally averaged speckle patterns, and by calculating the radial profile of the DRP∥ and DRP⊥ patterns using a model derived from the light diffusion.

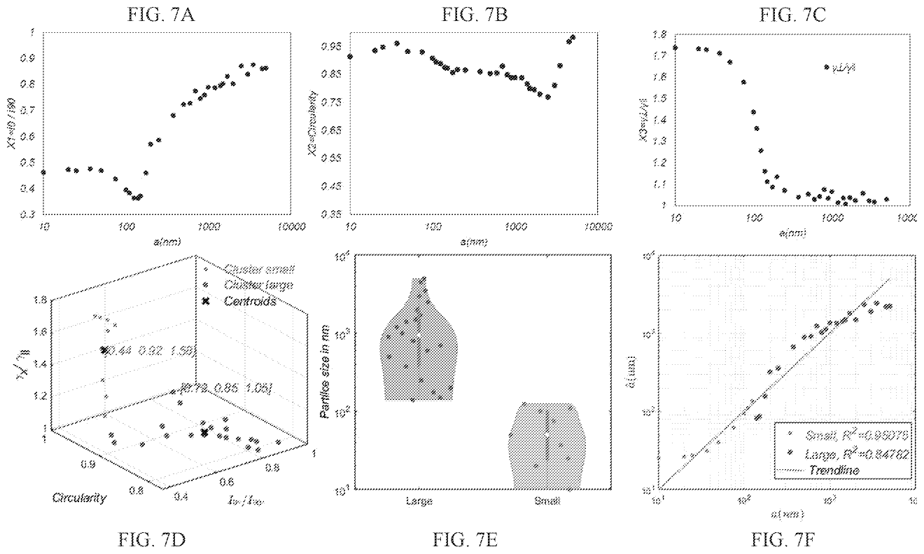

Therefore, for the moment, we assume that μs′ is known and focus on developing the prediction model for a given μs′ value of 1 mm⁻¹. FIGS. 7A-C display the X1, X2, and X3 attributes as a function of a assuming μₛ′=1. We note that the small and large particles exhibit different dependencies on the X₁, X₂, and X₃ variables. That is while the dependencies on the X₁ value for small particles is mostly linear, for large particles this decency is more of an exponential behavior. This observation calls for two different models for the ranges of small and large particles. To identify these sets of particles and the threshold for small vs large particles, we performed K-mean clustering which partitioned the simulated (X₁-X₃) space into 2 mutually exclusive clusters corresponding to a≤125 nm and a>125 nm and suggested that by measuring X₁-X₃, one can readily differentiate the and clusters particles to smaller and larger than 125 nm, based on their proximity and Euclidean distance from the centroids of the two clusters, as displayed in FIGS. 7D and 7E. The centroid of the clusters was calculated and recorded for all the μs′ in our exhaustive set. Subsequently, a step-wise regression model was used to obtain a prediction model of the particle size for small vs large particles as follows:

The scatter diagram in FIG. 7F shows the R square value for each of the fitted regions and the corresponding model. It is readily observed that the model for small particles is only dependent on the X3 variable, whereas the model for the large particle is related to 10^{X1}. While the prediction models streamline to simple models entailing either of X₁ and X₃ for large and small particles, all three parameters are required for the cluster analysis and identifying the cluster to which the particle of unknown size belongs.

$$Cluster Small : \hat{a} = 423 - 225 {X}_{3} \qquad ( 14 )$$

$$Cluster Large : log ( \hat{a} ) = 0.87 + 2.87 {X}_{1} \qquad ( 15 )$$

Repeating these steps for all the μs′ values and the 3D curves corresponding to the coordinates of the centroids as a function of μs′ are obtained together with the prediction models for all the μs′.

Subsequently, a unified model was derived that yields the particle size as a function of both μs′ and X₁-X₃, respectively. Therefore, while all X₁-X₃ parameters are used in the cluster analysis, the step-wise regression models streamlined the most significant parameters to be included in the prediction model.

$$Cluster Small : \hat{a} = 423 - 225 {X}_{3} Cluster Large : \{ \begin{matrix}{μ}_{s}^{′} \leq 1 & log ( \hat{a} ) = 0.64 + 3.14 {X}_{1} \\ 1 < {μ}_{s}^{′} \leq 2 & log ( \hat{a} ) = - 0.89 {μ}_{s}^{′} + 1.78 + ( 1.86 + {μ}_{s}^{′} ) {X}_{1} \\ 2 \leq {μ}_{s}^{′} & log ( \hat{a} ) = - 10 {μ}_{s}^{′} + 23.5 + ( 19 + 10 {μ}_{s}^{′} ) {X}_{1}\end{matrix} \qquad ( 16 )$$

The above clustering model equations show that only X1 and X3 are the most significant parameters in the context of highly scattering samples with varying reduced scattering coefficients, μₛ′, with negligible absorption and a priori refractive index mismatch. While X₂ does not appear in the model, it is incorporated in the prior clustering step that assigns the specimen to either the small of the large cluster. In addition, alternate clustering models may be used that will likely show X₂ as an additional significant parameter particularly in the context of materials with non-negligible optical absorption and in samples where refractive index mismatch is included as a model parameter to be recovered. This is because X₂ is inversely proportional with the absorption and g, but positively correlated with μₛ′. Therefore, we envision that in highly absorbing samples, X2 will be critical in decoupling and isolating the influence of optical properties on X₁ and X₃ when predicting a, and could show up as a main factor as an interaction factor in the step-wise regression model.

### Simultaneous Extraction of Optical Properties and Particle Sizes of Tissue and Turbid Materials:

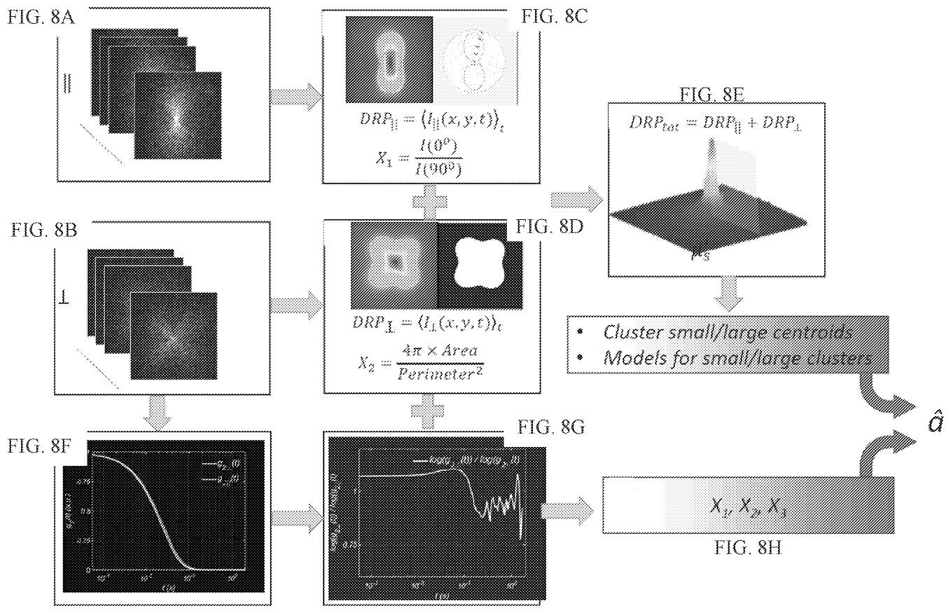

The development of the model is a one-time process, and this model may be readily applied to predict the scattering particle size from the polarization-dependent attributes of the laser speckle, using a simple workflow in the actual experimental setting as displayed in FIG. 8.

Firstly, the parallel and perpendicular polarized speckle patterns are acquired. Next, temporal averaging of the speckle patterns yields the DRP∥ and DRP_{⊥} from which X₁, X₂, and μₛ′ are extracted. Next, the cluster centroids and the prediction model are determined based on the μₛ′. In addition, temporal cross-correlation analysis of speckle frames provides the g_{2⊥}(t) and g_{2∥}(t), from which X3 is evaluated as X3=log(g_{2⊥}(t))/log (g_{2∥}(t)). Finally, X₁-X₃ are plugged into the prediction model to obtain the a.

### Results

### Testing and Validation Studies:

The above systems and methods are tested in tissue samples and optically turbid media as detailed below.

### Validation in Polystyrene Bead Suspensions:

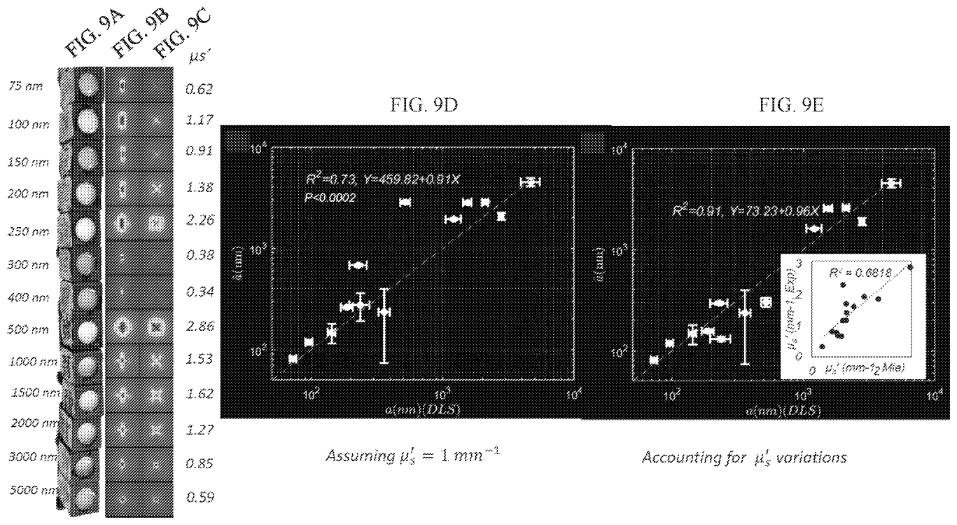

We validated this workflow and model in mono-dispersed polystyrene beads suspended in glycerol solutions, as shown in FIG. 9. Inert aqueous polarization microspheres suspensions of 10% weight fraction were obtained from the Bangs lab Inc. (NC, USA), exhibiting nominal radii in the range of 72.5 nm to 4800 nm (N=14). The particle size values were verified using DLS (e.g., Zeta Sizer Ultra, Malvern Instruments). For microspheres smaller than 500 nm, Polystyrene-glycerol suspensions were prepared in total concentrations of microsphere 1%, glycerol 90%, and water 9%. For microspheres 500 nm and larger, the suspensions entailed 3% microsphere, 70% glycerol, and 27% water. Mie theory was used to estimate the μs′ of the polystyrene microsphere phantoms. The specimens were pipetted into a custom 3D printed cuvette and the speckle frame series were acquired at 1808 frames per second for 2 seconds in both parallel and perpendicular polarization states over 5 different points on the sample surface.

Mie theory calculations were used to calculate the μs′. Additionally, μs′ was experimentally calculated from the DRP∥ and DRP_{⊥}. The experimentally evaluated μₛ′ exhibited reasonable correspondence with theoretical calculations (r²=0.68, p<0.0001). The variations between experimental and theoretical values may be attributed to differences in the actual concentrations, caused by errors in pipetting of the high viscosity glycerol dispersants. We used the model derived from μₛ′=1 to the sizes which resulted in an R-square of only 70% and p-value of 0.0002. When using the same μₛ′=1 for all the beads, the prediction model fails to estimate the accurate particle size. This is because X₁, X₂, and X₃ depend not only on a, but also on μₛ′.

For instance, X₁ increases when either of a and μₛ′ are increased. As such two specimens with the same X₁ but different μₛ′ likely exhibit different scattering particle sizes. However, if the influence of μₛ′ is overlooked, the model could declare the same size for the two specimens. In addition, the centroid of the small and large clusters also depends on the μₛ′. Therefore, if μₛ′ is not taken into account, the specimen may be assigned to the wrong cluster and the wrong model may be used to predict the particle size. On the other hand, if the model accounts for the correct μₛ′ in the prediction equation, the estimation of the particle size will be more accurate. FIG. 9E displays the scatter diagram of the estimated particle size, obtained from μₛ′-dependent model, vs the DLS measurements. One could observe that data points are a lot less scattered and closer to the trend line. In addition, the R square reaches to above 0.9 and reduced the p-value to below 0.0001. Taken together, these observations suggest that by using the μₛ′-dependent model the prediction is improved significantly.

### Example Application in Breast Carcinoma Prognosis:

In on example, fresh, excess, and de-identified human breast carcinoma specimens were collected from patients undergoing breast cancer surgery (mastectomy or lumpectomy) or breast reduction surgery between March 2015-December 2022. The clinical diagnosis for each specimen, the tumor size, histopathological grade, hormonal receptor status, lymph node status, and the history of neoadjuvant chemotherapy or radiation therapy was obtained from pathology records. The samples were refrigerated at 4° C. and imaged within two hours of being grossed. Prior to laser speckle measurements, the sample was marked with ink, warmed to 37° C. in a water bath, placed in a sample holder. Thew sample was linearly scanned, and the speckle frame series were captured in parallel and perpendicular polarization states in 1 mm steps across the sample, at a frame rate of 250 fps for 2 seconds. After imaging, each sample was fixed in 10% formalin, sectioned at 100 μm increments in depth (7 μm thickness per section), and stained with hematoxylin and eosin (H&E), and Picrosirius Red (PSR). The H&E slides were digitized using Nano-zoomer 2.0 HT whole slide scanner (Hamamatsu, Japan). Fiducial ink marks in the sample photographs and brightfield images were used to co-register the speckle measurements with histology. Pathologist blinded to the SHEAR data provided histopathological analysis from H&E slides.

In this study, we investigated the applicability of our prediction method for particle sizing in normal and malignant breast tissues. In the case of tissue, the particle size distribution is highly poly dispersed. In addition, refractive index variations and absorption properties may not be negligible.

Having these limitations in mind, we applied the model to a pilot set of the tissue sample, as displayed in FIG. 10. In normal adipose tissue, the DRP_{∥} presented a clover-like pattern, with X₁ value of 0.77. In addition, DRP_{⊥} exhibited reduced circularity, corresponding to X2=0.78. Replacing X1-X3 in the model yields a=1.8 microns which reflects the large size of the fat cells as evidenced by the histology slides. The next sample was a plainly homogenous benign fibrous specimen. This sample has a significantly smaller X₁ value of 0.56, indicating that the particle size is significantly smaller in the fibrous specimen. The prediction model declared a particle size of a=150 nm for this sample, which likely reflects the size scales of the ECM fibers. Lastly, the X₁-X₃ values of two heterogenous invasive ductal carcinoma specimens are displayed. The first specimen is a grade 1 IDC, that exhibits ER+/PR−/HER2− status, whereas the second specimen is a highly aggressive triple negative grade 3 IDC. These two specimens are highly heterogeneous both in terms of the size scales of the structures and their refractive index variations. While our model is developed based on mono-dispersed poly beads, applying this model to the low and high-grade IDC indicates that the particle size in the high-grade tumor is higher than that of the low-grade tumor. Applying this model to a pilot set of breast carcinoma (N_{grade1}=1, N_{grade2}=5, N_{grade3}=7) also reflects this trend that the average particle size seems to increase with the tumor grade (α_{GradeI}=640 nm, α_{GradeII}=1020 nm, α_{GradeIII}=1060 nm).

Next, we investigate the feasibility of using our model in heterogeneous and highly polydisperse soft tissues by scanning along a line in a breast carcinoma specimen that was sandwiched between and invaded into adipose tissue from the two ends, as displayed in FIG. 11A. The particle sizes obtained along the scanned line (see FIG. 11B) reflected the variations in the tissue compartments. Namely, the particle size was larger at the two ends where the carcinoma met the fat tissue, suggesting that by scanning the laser beam across the tissue a map of particle size may be measured.

### Example Application in Platelet Function Testing:

Next, we tested and verified the potential of exploiting laser speckle attributes for the accurate and sensitive detection of platelet activation, aggregation, inhibition, and monitoring the change of effective aggregate size in whole blood specimens obtained from patients and spiked with combinations of RBC lysis buffer ammonium chloride, potassium carbonate and EDTA 10X, BioLegend® platelet agonist ADP, and the anti-platelet agent clopidogrel bisulphate (CPD). ADP is a mild agonist that targets the P2Y₁ and P2Y₁₂ platelet receptors. The P2Y₁ receptor is responsible for platelet shape changes and the primary wave of aggregation. The P2Y₁₂ receptor on the other hand mediates the secondary phase of aggregation and is the major target of the anti-platelet drug, clopidogrel (e.g., Plavix). To prepare the 4660 μM CPD stock solution, a Plavix tablet (e.g., 75 mg, Bristol-Meyer Squibb) was crushed to powder, mixed with 50 ml of deionized water, sonicated for 10 minutes, and incubated at 50° C. in a water bath for 3 minutes. Following institutional review board (IRB) approval, de-identified blood specimens from two patients undergoing routine coagulation testing were collected in 0.105 M sodium citrate vacutainer system (e.g., Becton & Dickinson, Co., Franklin Lakes, NJ, USA) from the MGH special coagulation laboratory. The specimen was divided into four samples of 66 μl. The first sample (control) was mixed with 20 μl of saline. The second sample was mixed 5 μl of saline and 10 μl of LB. The third sample was mixed with 5 μl of saline and 10 μl of LB, and 5 μl ADP stock solution (e.g., 5 μM, Helena Laboratories, Beaumont, TX, USA). Finally, the 4^{th} and last sample was mixed 10 μl of LB 5 μl of ADP and 5 μl of diluted CPD (5 μM). The samples were loaded in imaging chambers and speckle image acquisition started promptly. For each of the specimens, both the parallel and perpendicularly polarized speckle frames were captured for 1 second, at 750 fps.

In these samples, the blood was lysed to significantly reduce the contribution of RBCs to the scattered light, which helped bring forth the signature of the platelets in the speckle pattern. In the process of haemolysis, the bursting of the RBC membrane releases the cytoplasm into the plasma and diminishes the refractive index mismatch between RBC and plasma, which is the major source of light scattering in blood. The refractive index matching caused by haemolysis is accompanied by a decrease of scattering coefficient, μₛ and an increase of anisotropy factor, g of blood, which together significantly decrease the reduced scattering coefficient, μₛ′=μₛ×(1-g) of the blood. Mie theory analysis of haemolyzing blood suggests that at 633 nm the μₛ is reduced from nearly 95 mm⁻¹ in whole blood to 55 mm⁻¹ in blood specimens with 20% of haemolysis. On the other hand, g increases from 0.9945 in whole blood to 0.9953 in blood specimens with 20% of haemolysis. As such, μₛ′ reduced from 0.52 mm⁻¹ to 0.22 mm⁻¹.

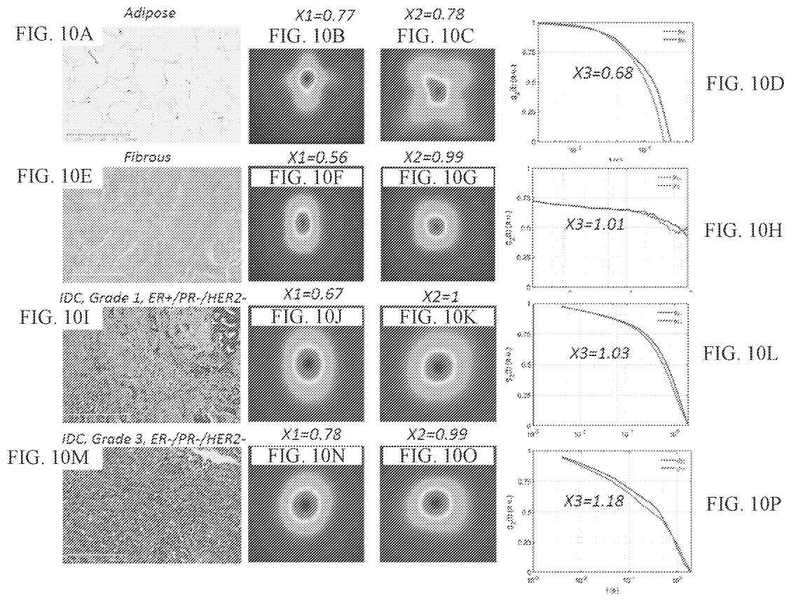

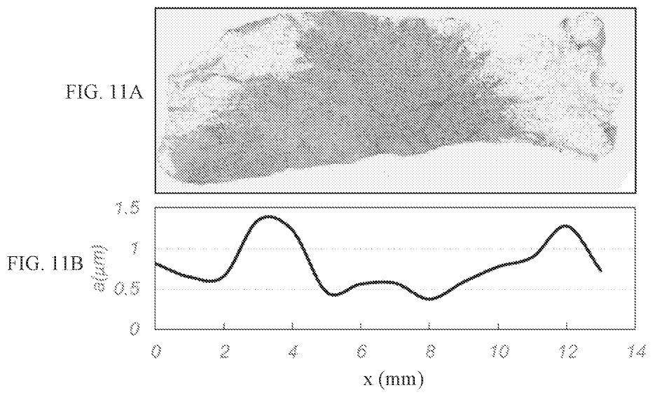

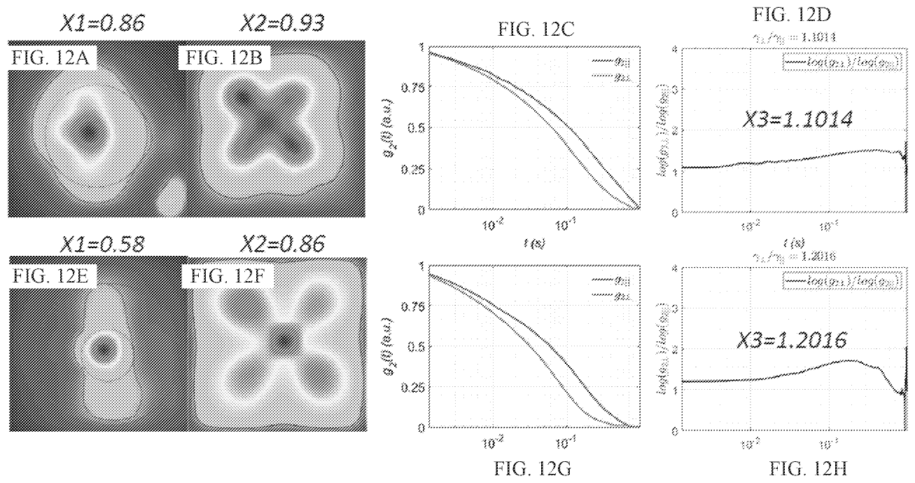

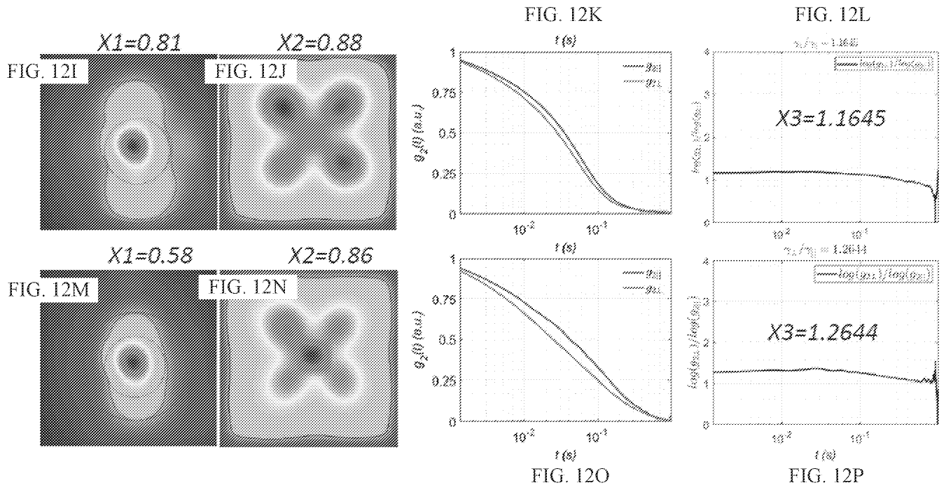

In our study, we observed that the μₛ′ reduced from 1.16 mm⁻¹ in whole blood to 0.4 mm⁻¹ in the lysed blood. The third sample entailed 66 μl of whole blood plus 5 μl of PBS, 10 μl of lysis buffer, and 5 μl Adenosine diphosphate (ADP), a platelet agonist to initiate platelet aggregation. Finally, the 4^{th} and last sample, entailed 66 μl of whole blood, 10 μl of lysis buffer, 5 μl ADP, and 5 μl of Clopidogrel (CPD), a platelet inhibitor was added to the whole blood to reverse the platelet aggregation process. Results of our particle sizing return the average radius of 2.3 μm for the whole blood, consistent with but slightly smaller than the size of RBCs (see FIG. 12). For the lysed blood, the average particle size turned to be 360 nm, which may reflect RBC fragments and platelets. For the ADP activated lysed blood the estimated particle size increased to 1.8 μm, which likely reflects platelet aggregation. Finally, for the lysed blood spiked with both ADP and CPD, the estimated particle size reverts back to 367 nm, which potentially indicates the disaggregation of platelets. It is to be noted that our model only accounted for variations in μₛ′ and assumed that the absorption coefficient μₐ is negligible. However, in the case of blood, at 632 nm, the effect of absorption may not be overlooked. This may explain the underestimation of RBC size in whole blood, as increased absorption is expected to terminate the longer optical paths and reduce the X1, which in turn would lead to the underestimation of the particle size. Additional simulations are needed to enhance the prediction model to include the role of absorption.

### Example Application in Diagnosing Hemolysis:

We also tested the potential of using the polarization-dependent laser speckle attributes for detecting haemolysis. To investigate the feasibility of detecting the haemolysis based on the polarization-dependent attributes of the laser speckle, we spiked 75 μl of whole blood, from a healthy donor, with 15 μl of RBC lysis buffer, containing ammonium chloride, potassium carbonate and EDTA (e.g., 10X, BioLegend®). The sample was immediately pipetted into an imaging chamber and the parallel and perpendicularly polarized speckle frames were captured for 1 second, at 750 fps, every 10 seconds, for 30 cycles, i.e., 5 minutes.

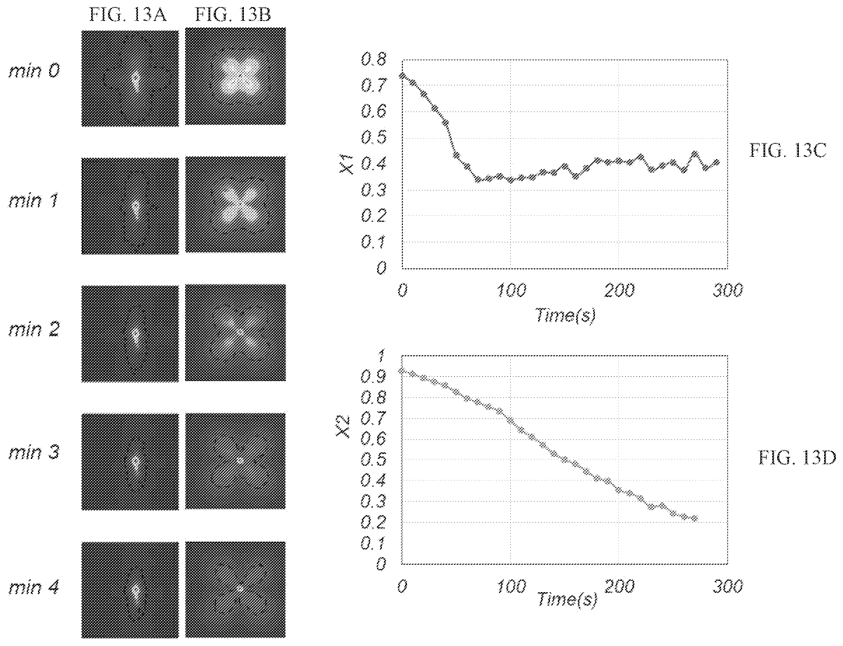

The back-scattered speckle patterns in both parallel and perpendicular polarized channels presented a significant spatial modification in a few minutes. Temporal averaging of the speckle frames corresponding to each imaging cycle yield DRP∥ and DRP_{⊥}, as presented in FIG. 13. The DRP_{⊥} evolved from a bright, concentrated clover-like pattern to a dim, expanded one, with the progression of hemolysis. The outer contours of the DRP, at intensity of 10% with respect to the illumination center were plotted. The X2 parameter was calculated as the circularity of the area contained within the outer contours. Accordingly, X2 reduced from 0.92 at the onset of lysis and gradually reduced and plateaued at 0.22 after completion of the lysis in 5 minutes. This reflects a significant rection in μₛ′, which indicates both the reduced RBC concentrations and refractive index mismatch. On the other hand, DRP∥ evolved from a clover-like shape to an elliptical form with the progression of hemolysis. This shape change was quantified by calculating the ratio of the short to long axis of the DRP_{∥}, which reduced from 0.75 to 0.35, likely indicating a reduction in the size of scattering particles.

The salient innovative hardware and software are listed below:

A Polarization Sensitive Correlation Transfer Monte-Carlo Ray Tracing (PSCT-MCRT) algorithm to simulate backscattered average intensity and speckle intensity decorrelation as a function of the particle size distribution, concentration, and refractive index mismatch as well as illumination and collection polarization states.

An algorithm that processes the PSCT-MCRT output and both the time-averaged and time-resolved polarization-dependent attributes of the speckle, namely DRP∥, DRP_{⊥}, g2⊥(t), and g2∥(t).

An algorithm to extract X1, from DRPII, as the ratio of the intensity along the horizontal axis to that of the vertical axis. This parameter is calculated by contorting the DRP∥ at 30% of the maximum intensity and identifying the inner and outer circles of the contour. The value of the intensity between these two circles is plotted as a function of the angle and the ratio is calculated as the X1 parameter.

An algorithm to extract the X2, defined as the circularity of the simulated cross-polarized DRP. This value is obtained by contouring the DRP_{⊥} at the 30% intensity level of the maximum and calculating the ratio of the area to the perimeter squared. The more lobulated the pattern, the lower the circularity. This parameter is often maximized for very large and very small particles and hits its minima when the g parameter is maximized, independently of μs' value.

An algorithm to extract the X3, defined as the ratio of the log of g2⊥(t) to the log of g2∥(t) and tabulate it as the third parameter.

An exhaustive set with all the potential observations, including X1, X2, and X3, and any other attribute and enable clustering the particles based on the polarization aspects of laser speckle and the optical properties of the sample.

A clustering method that permits differentiating small and large particles based on the corresponding X1, X2, X3.

Two comprehensive multiple regression models for small and large particles that predicts the particle size from X1, X2, and X3, among others, and account for variations in μs′, μa, and g to enable predicting the scattering particle size in specimens of optical properties.

A hardware that enables capturing the speckle frame series at two linear parallel and perpendicular polarizations states with respect to the illumination.

One temporal averaging mechanism of the experimentally-evaluated speckle patterns to deduce the DRP∥ and DRP_{⊥} from the speckle frame series.

One temporally resolved mechanism for deducing the speckle intensity autocorrelation functions in parallel and perpendicular polarization states, g2⊥(t), and g2∥(t), from the speckle frame series.

A workflow of processing the actual experimental speckle frame series, as displayed in FIGS. 4 and 7. In this workflow, Speckle frame series are obtained at two linear parallel and perpendicular polarization states with respect to the illumination.

Temporal averaging of the parallel polarized experimentally-evaluated speckle series yields the DRP∥, from which X1 is calculated. X1 is the ratio of the parallel-polarized diffuse reflectance, DRP∥ at 90° to 0° azimuth angles. It is calculated by contorting the DRP∥ at 30% of the maximum intensity and identifying the inner and outer circles of the contour. The value of the intensity between these two circles is plotted as a function of the angle.

Subsequently, the ratio is calculated as the X1 parameter.

Temporal averaging of the perpendicularly polarized experimentally-evaluated speckle series yields the DRP⊥. To calculate the X2, DRP_{⊥} is contoured at the 30% intensity level of the maximum and the ratio 4πA/P² is calculated. Here, A is the area and P is the perimeter of the contour. The more lobulated the pattern, the lower the circularity.

The total DRP is calculated as DRP∥+DRP_{⊥}. The radial profile of DRP is fitted to a model derived from diffusion equation to extract the μₛ′. The μₛ′ determines the cluster centroids and the prediction model.

Temporally resolved analysis of the speckle frame series yields the speckle intensity autocorrelation functions in parallel and perpendicular polarization states, g2⊥(t), and g2∥(t). X3 is calculated as log (g_{2⊥}(t))/log (g_{2∥}(t)).

X1, X2, and X3 are replaced in the model to yield estimated particle size, \hat{α}.

These innovative features may be expanded and alternated with additional methods as listed below.

### Additional Exemplary Systems & Methods

For instance, here we exploited one nuance of the PSCT-MCRT algorithm to develop a novel particle sizing approach that enabled estimating the size of scattering particles from the polarization-dependent attributes of the laser speckle pattern. The prediction model developed in this study, was based on assuming a mono-dispersed sample with negligible μₐ. However, in reality biological samples are highly polydisperse and may exhibit significant light absorption. Since increasing of μₐ would reduce and prune the long optical paths, we envision that the trends of X₁, X₂, and X3 with the growth of μₐ would resemble the trends experienced with the reduction of μₛ′. As such, to collectively account for optical properties, additional PSCT-MCRT codes may be used to create additional exhaustive libraries to create an ultimate model which includes the ratio of the two coefficients, namely: μₐ/μₛ′. Additional PSCT-MCRT simulations could fully characterize the influence of all the optical properties on the polarization-dependent attributes and to permit unique extraction of the particle size from the attributes. Alternatively, even more simulation algorithms may be developed to account for the asymmetry parameter, g, variations independent of the variations in μₛ. The additional algorithm could also simulate a poly-dispersed specimen, with varying fractions of small and large particles.

Similarly, the apparatus for acquiring laser speckle attributes may be embodied in several different configurations. FIG. 2 displays an alternative instrument, based on using a polarizing modulator, which circumvents the need for having two different cameras. This system 100′ enables capturing the cross and co polarized speckle patterns in a consecutive manner.

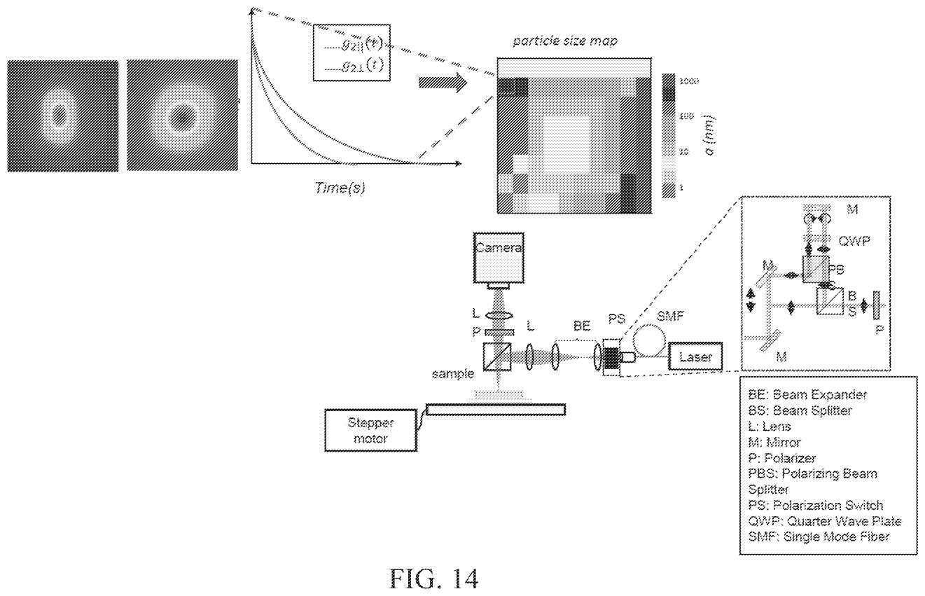

This setup may be used in a scanning mode geometry, to permit particle sizing across a heterogeneous polydisperse tissue, as displayed in FIG. 14.

Alternatively, a commercial or home-made polarization modulator mat be developed that intermittently switched between the polarization states at a rate synchronized with the camera frame rate rate. In such an alternate setting, only one series of speckle frames are acquired with alternate frames corresponding to orthogonal polarization states. In other words, the parallel and perpendicularly polarized speckle frame are interleaved within one frame series. The advantage of this acquisition is that it permits demultiplexing the frame series to two set of frame series that are precisely acquired at the same instants of time and location on the sample and are reflecting the exact same dynamics albeit at two different polarization states. More specifically, when speckle frame series are acquired one at a time, and sequentially, there is possibility that the sample dynamics or environmental vibrations are modified for each acquisition. The multiplexed acquisition ensures that these differences and biases are minimized.

Alternatively, sample may be illuminated by a circularly polarized beam of light and acquiring the corresponding parallel and perpendicular circularly polarized speckle frame series. The ratio of the circularly polarized g2(t) curves,

$${X}_{3}^{′} = \frac{{g}_{2 \text{?}} ( t )}{{g}_{2 \text{?}} ( t )} \qquad ( 17 )$$

Is expected to exhibit a trend as a function of particle size, which is the opposite of what is seen in X₃. That is while X₃ reduces with the particle size, X₃′ grows with the particle size. Therefore, acquiring the circularly polarized speckle frames could also help extend the range over which the particle size may be extracted from the polarization-dependent attributes.

To accommodate circular polarizations, a second quarter wave plate may be added to the polarization modulator in FIG. 2, which permits converting the tow linearly polarized breams to circular ones. In this approach, circularly polarized beams of alternating states will be acquired in the single speckle frame series, in a n interleaved, multiplexed manner.

Alternatively, more sophisticated polarization modulators maybe employed that permit switching between linear and circular polarizations of orthogonal states. Accordingly, a more sophisticated analyzers may be employed that enable acquiring the scattered light at various polarization states. Therefore, the DRP pattens may be acquired with all possible combinations of illumination and collection polarization states, which enable characterizing the total Mueller matrix of the sample, which relates the incident Stokes Vector to that of the acquired Stokes vector as follows:

$$[ \begin{matrix}{I}_{R} \\ {Q}_{R} \\ {U}_{R} \\ {V}_{R}\end{matrix} ] = M [ \begin{matrix}{I}_{i} \\ {Q}_{i} \\ {U}_{i} \\ {V}_{i}\end{matrix} ] \qquad ( 18 )$$

Additionally, the equivalent g2(t) curves may be obtained.

Together the combination of all possible g2(t) ratios and the features of DRP patterns could provide a more comprehensive understanding of the scattering matrix and shed light on the shape, size distribution, and birefringence aspects of the sample.

In addition to the PSCT-MCRT model and the hardware, the software may be modified to include additional steps in the workflow of the particle sizing, by including additional polarization-dependent attributes. While we have characterized 3 polarization-dependent attributes of the laser speckle, additional attributes may be included in the model. One such attribute is X₄, which is spatially varying ratio of the g2(t) curves, which is the ratio of the log of g_{2⊥}(t) in the peripheral regions of the speckle pattern to that of the log of g2∥(t) in the central part of the speckle pattern. For this purpose, the ring analysis of the speckle patterns may be performed, dividing the speckle pattern into for instance 5 concentric rings. Subsequently, the radial dependent log ratios of the g_{2⊥}(t) and g_{2∥}(t) may be evaluated. While these ratios are largely a scaled version of X3, they tend to decrease slightly slower with the particle size and may improve the prediction model

### Additional Systems and Methods for Measuring Particle Size, Independent of Optical Properties Termed

### Laser Speckle Particle Sizer (SPARSE)

Particle sizing of biomaterials and tissues holds profound implications across diverse industrial and clinical domains. The nm-μm range granularity exhibited by biomaterials and tissues encompasses a spectrum of endogenous particle sizes. Current methodologies fall short in assessing particle size distribution in intact, untampered biomaterials and tissues of arbitrary and unknown optical properties in their native state. Embodiments of the disclosure provide an additional Laser Speckle PARticle SizEr (SPARSE) approach, that leverages the size-dependent characteristics of polarized back-scattered laser speckle to characterize the average size of endogenous scattering particles within intact biomaterials and tissues within the 50 nm-5 μm range, without the need to first estimate the optical properties. Therefore, we are also enclosing another variation of laser speckle based particle sizing that permits estimating the scattering particle size, without the need to estimate the optical properties as an intermediate step. Rather, this second approach, directly measuring the particle size in samples of arbitrary scattering and absorption properties in one go To this end, SPARSE employs a fourth polarization-dependent attribute of laser speckle X4, from the intensity envelope of the perpendicularly polarized speckle the implicitly corrects for the variations of optical properties, without directly introducing them in the prediction model, as above. Employing a scanning approach across tissue surfaces, SPARSE generates high-resolution (150 μm) maps of particle size distribution in heterogeneous benign and breast carcinoma tissue specimens. The capability to assess particle size in diverse biospecimens in their native state opens novel avenues for quality control in commercial applications and advances clinical diagnostics in medicine.

The ability to measure particle size, independent of optical properties is particularly helpful in the context of mapping the size distribution in heterogeneous tissue where different spatial locations could exhibit additional variations in optical properties, hindering the applicability of the above-introduced first approach, that calls for the estimation of μₛ′ from the diffuse reflectance profile. It also extends the applicability of laser speckle particle sizing approach to specimens of considerable absorption properties, and non-negligible absorption coefficient, μₐ, where the above method that ignores absorption, may not be adequate.

Below, we enumerate some additional applications, where variations in optical properties are more pronounced and the laser speckle particle sizing independent of optical properties may be desired. We also specifically discuss the shortcomings of existing techniques in the context of arbitrary and unknown optical properties of most biomaterials

Particle size characterization poses a widespread challenge across scientific disciplines, including pharmaceutical research, food processing, and diagnostic pathology. In pharmaceuticals, sizing nanodrug carriers like liposomes and micelles, a crucial aspect of formulation, involves decomposing the drug bolus into its essential components. Similarly, in the food industry, invasive techniques are used for sizing lipid droplets during processes like homogenization and fat reduction, through titrating dairy products in solvents for accurate sizing purposes.

Moreover, the diagnosis and management of hematological disorders, including anemias, thalassemia, myelodysplastic syndromes, and age-related degenerative disorders, hinge on evaluating Mean Corpuscular Volume (MCV) in red blood cells (RBCs) using sophisticated hematology analyzers. Additionally, grading malignant tumor cells requires visually assessing cell and nucleus size distributions in stained tissue slides, scrutinizing skewed size distributions of tissue particularities. Therefore, the ability to rapidly assess the particle size within intact food products, biomaterials, and tissues in their native state offers invaluable opportunities for quality control and diagnostic medicine.

Proximity of optical wavelengths to the μm range confers a close relationship between back-scattered light patterns and particle characteristics, affording the light with superior resolution for revealing minute particles' structures. This has led to the emergence of Dynamic Light Scattering (DLS) and Laser Diffraction (LD) as industrial gold standards for particle sizing. Competent in sub-micron range, DLS is based on evaluating the intensity fluctuations of back-scattered light, to extract the diffusion coefficient of particle's Brownian motion, and in turn their size. In contrast, LD assesses the angle-dependence of the light diffracted from dispersed particles, and fits it to Mie or Fraunhofer theory for size inference at larger scales, up to a few millimeters. Yet, the intricate instrumentation and the necessity to conform to the single-scattering approximation via dispersing the particles in low-viscosity solvents reduces the applicability of both techniques in intact biomaterials and tissues. This has created a technological gap in the assessment of size within a continuum of granularities without decomposing the specimen.

Therefore, a majority of the commercialized previous arts are limited to very dilute nearly transparent samples of negligible optical scattering and absorption coefficient. That is in such prior art, both μₛ′ and μₐ are zero. As such these technologies are not applicable to biological tissues and biomaterials of unknown or arbitrary optical properties.

To bridge this gap, a low-cost miniaturized LD equivalent was developed that permitted sizing in concentrated specimens through eliminating the complex detection schemes necessary for high resolution measurements of angular scattering distribution in conventional LD. This was achieved by means of a spatial array of apertures with assorted diameters, each admitting distinct sets of scattering angles. A machine learning model corrected for multiple scattering and predicted the size. However, demonstrations were limited to measuring the median diameter of mono-dispersed large glass beads in the 13-125 μm range, showing less accuracy without concentration, and in a sense the reduced scattering coefficient, μₛ′, as an input, and hence, not conducive for biological specimens with smaller size scales and variable particle concentrations, and in turn, optical properties.

In the pursuit of a non-invasive optical probe of size distribution, focus has shifted to laser speckle, a granular intensity pattern formed when a coherent laser beam back-scatters from a rough surface or a turbid volume. Formed because of differences in photon trajectories and optical phases of individual rays, spatio-temporal variations of speckle intensity are exquisitely sensitive to the sample microstructure and dynamics. Spatial autocorrelation of speckle is demonstrated to informs the particle size distribution of powdered solid drugs in the 100-500 μm range. Nevertheless, this former approach is mostly suited for sizing powdered solids of larger grain sizes spread on a surface, during processes such as drying, blending, and milling and presents limited applicability to biomaterials. In addition, calculating the spatial autocorrelation inherently removes spatial information, precluding the mapping of size distribution heterogeneities within a single sample. In addition, while capable of predicting the emergence of large aggregates, this approach only yields a unimodal distribution and fails to predict secondary peaks in the distribution.

We introduce the Laser Speckle PARticle SizEr (SPARSE), a novel non-invasive approach that exploits the back-scattered polarized laser speckle patterns to characterize the size scales of endogenous granularities in the 50 nm-5 μm range within intact biomaterials and tissues of arbitrary and unknown optical properties. When a laser beam is tightly focused is tightly focused on the sample, a millimeter-scale intensity envelope, also known as diffuse reflectance, is generated that is modulated by the time-varying microscale speckle intensity grains. Capturing the speckle through a linear polarizer, oriented either parallel or perpendicular to the illumination, modifies the temporal fluctuations rate the of speckle grains and the spatial profile of the intensity envelope, in concert with the size. Here, we demonstrate that through polarimetric analysis, SPARSE evaluates a set of attributes and integrates them into a simple to implement, intuitive prediction algorithm that implicitly accounts for variations in optical properties to estimate scattering particle size across a diverse range of biomaterials and tissues without prior knowledge of concentration or refractive index variations.

Our demonstrations encompass polystyrene microspheres, milk phantoms, whole blood, as well as normal and carcinoma-bearing human breast tissue specimens, which present a wide range of optical scattering and absorption properties, size scales, and polydispersity indices. Additionally, by scanning the focused beam across the sample surface, we demonstrate the capacity of SPARSE to map the spatially resolved size heterogeneities within both benign and carcinoma-harboring human breast tissue specimens. By facilitating size characterization of intact tissues and biomaterials across a continuous spectrum of granularities, without the need to decompose the specimen to its elements, SPARSE presents promising potentials for diverse applications in both industrial and clinical settings.

### Methods for Measuring Particle Size, Independent of Optical Properties

Biological tissues are comprised of minute nm to μm size particles, executing continuous thermal motions. When a coherent, linearly polarized beam is focused on tissue, photons traverse the illuminated volume along different paths and scatter multiple times of these intrinsic particles, forming distinctive laser speckle patterns upon reemerging at the surface.

If tissue particularities are smaller than light wavelength, most photon trajectories involve only a few wide-angle scattering events that largely preserve the incident polarization, forming the parallel or co-polarized component of the speckle pattern. The time-averaged intensity of co-polarized rays, denoted by Î_{∥}, exhibits a double-lobed profile aligned with the polarization axis. A fainter, more dynamic, cross-polarized speckle is contributed by the longer, less common paths. Therefore, temporal intensity autocorrelation of cross-polarized speckle, g_{2⊥}(t) decay much faster than co-polarized one, g2∥(t).

Conversely, when particle size exceeds laser wavelength, anisotropic forward-scattering leads to discursively long photon trajectories with an equal affinity for co- and cross-polarizations. Consequently, Î_{∥}, transforms into a four-leaved pattern, growing a second pair of lobes perpendicular to the polarization axis. Moreover, differences in the decay rates of g2⊥(t) and g2∥(t) are diminished. In contrast to Î_{∥}, time-averaged intensity of cross-polarized rays, Î_{⊥} maintains a four-leaved shape, irrespective of particle size. However, the circularity of Î_{⊥} is reduced and its lobes become increasingly distinguished when particle size matches the wavelength.

Aside from particle size, the optical properties of tissue also affect these trends. Increased particle concentration and refractive index mismatch foster rich scattering, as quantified by the optical reduced scattering coefficient, μₛ′. This shrinks the radial extents of Î_{∥} and Î_{⊥}, bringing forth the longer optical paths, promoting a four-leaved Î_{∥} shape, and a wider gap between g_{2⊥}(t) and g2∥(t). Conversely, increased absorption coefficients μa, relative to μs′, prunes the longer paths, pushing the Î_{∥} to the double-lobed pattern and closing the gap between g2⊥(t) and g2∥(t) 21,22. SPARSE leverages the polarimetric analysis of the laser speckle to capture these trends via an array of attributes, denoted as [X1, X2, X3, X4], and incorporates them in a consolidated prediction algorithm to estimate the scattering particle size, a (see FIG. 15).

### Materials and Methods of the SPARSE Approach for Particle Sizing, Independent of Optical Properties

According to embodiments of the disclosure, an optical setup, similar to that shown in FIG. 1 can be used. In one example, a SPARSE optical setup can include a polarized laser beam (e.g., Thorlabs, HNL210LB, 633 nm, 21 mW). In the example, the laser beam is collimated and expanded to a beam diameter of 1 cm, passed through a focusing lens (e.g., Thorlabs, LA1986-A, Plano-Convex, AR coated, f=124.6 mm), a beam splitter (e.g., Thorlabs, BS013, non-polarizing, beam splitter cube), resulting in a 10 μm spot of 5 mW on the sample surface. The backscattered light rays are collected and split into by a second beam splitter in two different light paths and detected by two different high-speed CMOS cameras (e.g., Basler, ACa 2000-340 km, Germany). A pair of macro-lenses (e.g., Computar, MLH-10X) and linear polarizers focus the back-scattered light onto the CMOS sensor of the two camera. Adjusting the macro-lens f/#to 11 and magnification to 1X, results in a speckle size of S=2.44λ(1+M) f/#=34 μm, and a one-dimensional pixel-to-speckle ratio of 5.7, ensuring sufficient spatial sampling, beyond Nyquist theorem.

The acquisition frame rate is selected according to the dynamics of the evaluated sample to ensure sufficient temporal sampling and adequate speckle contrast. The rotating mounts of the collection polarizers are adjusted so that the cameras acquire the co- and cross-polarized speckle patterns with respect to the illumination beam. To permit spatial mapping in heterogeneous biological tissues, the sample is placed in a holder and mounted on a 2-axis motorized stage (e.g., Newport, VP-25XA), controlled by a motion controller (e.g., Newport, ESP301). The sample is scanned in a serpentine pattern, with a scan pitch of 150 μm, to cover an area of a few mm. At each scanned spot, speckle frames are acquired at 390 fps, for a sensor ROI of 1.2×1.2 mm, for 2 seconds. A custom-build C++ acquisition software can enable adjusting the frame rate, exposure time, acquisition time, and frame size and synchronizes the motion controller and the cameras.

### Quantifying Size-Dependent Attributes of the Polarized Speckle Patterns (SPARSE)

Speckle frames were processed to obtain the diffuse reflectance profiles in the co- and cross-polarization states, Î_{∥}(x,y) and Î_{⊥}(x,y), as follows:

$${\hat{I}}_{\vert \vert} ( x , y ) = \frac{{〈 {I}_{\vert \vert} ( x , y , t ) 〉}_{t}}{max {〈 {I}_{\vert \vert} ( x , y , t ) 〉}_{t}} , {\hat{I}}_{⊥} ( x , y ) = \frac{{〈 {I}_{⊥} ( x , y , t ) 〉}_{t}}{max {〈 {I}_{⊥} ( x , y , t ) 〉}_{t}} \qquad ( 1 )$$

where, I_{∥}(x,y,t) and I_{⊥}(x,y,t) refer to speckle intensities at location (x, y) and time instance t, and ( )ₜ denotes temporal averaging.

In addition, speckle intensity autocorrelation curves for both co- and cross-polarizations are calculated according to:

$${g}_{2 \vert \vert} ( t ) = \frac{{g}_{2 \vert \vert , raw} ( t ) - 1}{{g}_{2 \vert \vert , raw} ( t = {t}_{0} ) - 1} , {g}_{2 \vert \vert , raw} ( t ) = {〈 \frac{{〈 {I}_{\vert \vert} ( x , y , t + {t}_{0} ) {I}_{\vert \vert} ( x , y , {t}_{0} ) 〉}_{t}}{{〈 {I}_{\vert \vert} ( x , y , t + {t}_{0} ) 〉}_{t} {〈 {I}_{\vert \vert} ( x , y , {t}_{0} ) 〉}_{t}} 〉}_{x , y} \qquad ( 2 )$$

$${g}_{2 ⊥} ( t ) = \frac{{g}_{2 ⊥ , raw} ( t ) - 1}{{g}_{2 ⊥ , raw} ( t = {t}_{0} ) - 1} , {g}_{2 ⊥ raw} ( t ) = {〈 \frac{{〈 {I}_{⊥} ( x , y , t + {t}_{0} ) {I}_{⊥} ( x , y , {t}_{0} ) 〉}_{t}}{{〈 {I}_{⊥} ( x , y , t + {t}_{0} ) 〉}_{t} {〈 {I}_{⊥} ( x , y , {t}_{0} ) 〉}_{t}} 〉}_{x , y}$$

where, raw g2(t) curves are normalized to the speckle contrast.

To calculate X1, Î_{∥}(x,y) is contoured at 30% of its maximum and the inner and outer circles of the contour are identified. Radial averaging of Î_{∥}(x,y) in the annular region between the two circles yields Î_{∥}(φ), from which:

$${X}_{1} = \frac{{\hat{I}}_{\vert \vert @ φ = 0 °}}{{\hat{I}}_{\vert \vert @ φ = 90 °}} \qquad ( 3 )$$

where φ stands for azimuth angle, and φ=90° corresponds to the direction aligned with the polarization axis of the illumination beam. Likewise, Î_{⊥}(x,y) is contoured at 30% of its maximum, and the area and perimeter of the contour, A and P, are evaluated to calculate:

$${X}_{2} = \frac{4 π A}{{P}^{2}} . \qquad ( 4 )$$

In addition, the differential decorrelation rate of co- and cross-polarized speckle frame series is quantified via:

$${X}_{3} = \frac{log ( {g}_{2 ⊥} ( t ) )}{log ( {g}_{2 \vert \vert} ( t ) )} {\vert}_{t = {t}_{m}} , \qquad ( 5 )$$

Where tₘ is the instance in time where the temporal derivative of g2(t) curves are maximized.

Finally, the average radius of the Î_{⊥}(x,y) contour is calculated as:

$${X}_{4} = \sqrt{\frac{A}{π}} . \qquad ( 6 )$$

FIG. 15 illustrates co-polarized (FIG. 15A) and cross-polarized (FIG. 15B) speckle frame series of a mono-dispersed polystyrene microsphere phantom of a=75 nm. FIG. 15D shows a temporal average of the acquired co-polarized speckle frame series, I_{∥}. The inset displays the contour of normalized I_{∥} at 30%. The long axis of the contour is aligned with the axis of polarization. I_{∥} is radially averaged in the annular region between the inner and outer circles of the contour, yielding an angular profile, from which

$${X}_{1} = \frac{{\hat{I}}_{\vert \vert @ 0 °}}{{\hat{I}}_{\vert \vert @ 90 °}}$$

is calculated. FIG. 15D shows a temporal average of the acquired cross-polarized speckle frame series, I_{⊥}. The inset displays the contour of normalized I_{⊥} at 30%, from which

$${X}_{2} = \frac{4 π A}{{P}^{2}}$$

is calculated, where A and P are the area and perimeter of the contour. In addition, X4 is evaluated as the average radius of the contour. FIG. 15E shows differential decorrelation rates of co- and cross-polarized speckle time series, defined as

$${X}_{3} = \frac{log ( {g}_{2 ⊥} )}{log ( {g}_{2 \vert \vert} )} ,$$

is obtained from the intensity autocorrelation, g2(t), of the acquired speckle time series (inset). FIG. 15G shows the [X₁,X₂,X₃, X₄] vector is assigned to one of five clusters, based on its Euclidean distance from the cluster centers. A linear model specific to that cluster estimates the average particle size, a, from the [X₁,X₂,X₃, X₄]

### Forward Model

We expanded our previously developed polarization-sensitive correlation-transfer Monte-Carlo Ray tracing approach, to simulate first- and second-order statistics of the polarized speckle, namely Î_{∥}, Î_{⊥}, g2∥(t), and g2⊥(t) in turbid media exhibiting the following size range and optical properties: a: 5 nm-10 μm, μs′: 0.5-4 mm−1, and μa: 0-30% μₛ′. Refractive indices of the particles and the surrounding medium were 1.59 and 1.45 respectively, and for each a, Mie theory calculations were used to adjust the particle concentration to attain the desired μₛ′ value. For each combination of [a, μs′=1 mm−1, μa/μs′], a total of 1 million photons were traced in the medium, as they scattered off from one particle and collided with the next until finally remerged back at the surface. A simple geometric scaling was used to generalize the results to entire μₛ′ range. At each scattering event, Mie theory was used to relate the parallel and perpendicular polarized components of the back-scattered light as a function of the incident light using a matrix with diagonal entries of the S1 and S2 parameters as follows:

$$[ \begin{matrix}{E}_{\vert \vert s} \\ {E}_{2 ⊥}\end{matrix} ] = \frac{{e}^{jk ( R - z )}}{- jkR} [ \begin{matrix}{S}_{2} θ & 0 \\ 0 & {S}_{1} ( θ )\end{matrix} ] [ \begin{matrix}{E}_{\vert \vert i} \\ {E}_{⊥ i}\end{matrix} ] \qquad ( 5 )$$

Here, Ei accounts for the incident field and Es represents the scattered electric field,
where

$${E}_{i} = {E}_{0} {e}^{- j k z + j ω} \qquad ( 6 )$$

In which the E0 is the magnitude, k is the wavenumber, z is the traveling direction of the incident beam and ω=2π/λ is the angular frequency. S1 and S2 depend on the size parameter x, or the ratio of the particle size to wavelength, the complex index of refraction of the particle, and the scattering polar angle theta through a series Riccati-Bessel functions, the spherical Bessel functions, and the spherical Henkel functions. Accordingly, during each scattering event, the direction of the photon changed in azimuthal, φ and polar angles, θ, based on joint probability distribution function of:

$$P ( θ , φ ) = {I}_{0} {S}_{11} ( θ ) + {S}_{12} ( θ ) [ {Q}_{0} cos ( 2 φ ) + {U}_{0} sin ( 2 φ ) ] \qquad ( 7 )$$

Here [I0, Q0, U0, V0] stands for the Stokes vector of the incident photon, which are related to the incident electric field components as follows:

$${S}_{11} = \frac{1}{2} ( {\vert {S}_{2} \vert}^{2} + {\vert {S}_{1} \vert}^{2} ) \qquad ( 8 )$$

$${S}_{12} = \frac{1}{2} ( {\vert {S}_{2} \vert}^{2} - {\vert {S}_{1} \vert}^{2} )$$

$${S}_{33} = \frac{1}{2} ( {S}_{2}^{*} {S}_{1} + {S}_{2} {S}_{1}^{*} )$$

$${S}_{34} = \frac{1}{2} i ( {S}_{1} {S}_{2}^{*} - {S}_{2} {S}_{1}^{*} )$$

In addition, the Stokes vector of the photon is updated using the single scattering function, as follows:

$$[ \begin{matrix}{I}_{S} \\ {Q}_{s} \\ {U}_{s} \\ {V}_{s}\end{matrix} ] = [ \begin{matrix}{S}_{11} & {S}_{12} & 0 & 0 \\ {S}_{12} & {S}_{22} & 0 & 0 \\ 0 & 0 & {S}_{33} & {S}_{34} \\ 0 & 0 & - {S}_{34} & {S}_{33}\end{matrix} ] R ( φ ) [ \begin{matrix}{I}_{i} \\ {Q}_{i} \\ {U}_{i} \\ {V}_{i}\end{matrix} ] \qquad ( 9 )$$

The distance traveled between the successive scattering events is randomly distributed with an average value of 1/μₜ, where μₜ=μₛ+μₐ, μₛ is the scattering coefficient and μₐ is the absorption coefficient. The PSCT-MCRT algorithm is executed for a matrix of particle size values and reduced scattering coefficients, assuming a fixed index mismatch, but varying particles concentrations. From these simulations, the parallel and perpendicular DRP as well as the g2(t) curves are extracted for the said matrix of μₛ′ and a values, as:

$$D R {P}_{\vert \vert} = IR + QR \qquad ( 10 )$$

$$DR {P}_{⊥} = IR - QR \qquad ( 11 )$$

$${g}_{2 \vert \vert}^{M C R T} ( t ) - 1 = {( {\sum }_{i = 1}^{n} {W}_{i} ( {I}_{i} + {Q}_{i} ) {e}^{- \frac{1}{3} {k}^{2} 〈 Δ {r}^{2} ( t ) 〉 {Y}_{i}} )}^{2} \qquad ( 12 )$$

$${g}_{2 ⊥}^{M C R T} ( t ) - 1 = {( {\sum }_{i = 1}^{n} {W}_{i} ( {I}_{i} - {Q}_{i} ) {e}^{- \frac{1}{3} {k}^{2} 〈 Δ {r}^{2} ( t ) 〉 {Y}_{i}} )}^{02} \qquad ( 13 )$$

Here, IR and QR are the total values of the first two elements of the stokes vectors on the surface, obtained by spatial binning of the Stokes vectors of the returning photons. In addition, Ii and Qi are the first two elements of the Stokes vectors of the individual returning photons. Moreover, Wi and Yi are the energy and momentum transfer of the individual returning photons.

The PSCT-MCRT algorithm was executed for a matrix of particle size values a, ranging from 5 nm to 10 μm, μs′=1 mm−1, and μa ranging between 0 and 0.3 mm−1, in 0.02 mm⁻¹ increments. A simple geometric scaling yield the photon trajectories for all possible combinations with μs′=0.5-4 mm−1 range.

From this exhaustive set of simulated Î_{∥}, Î_{⊥}, g2∥(t), and g2⊥(t), we calculated the size-dependent attributes [X1, X2, X3, X4] for each [a, μs′, μa/μs′] combination. This forward model between [a, μs′, μa/μs′] and [X1, X2, X3, X4] was used to develop the SPARSE prediction algorithm.

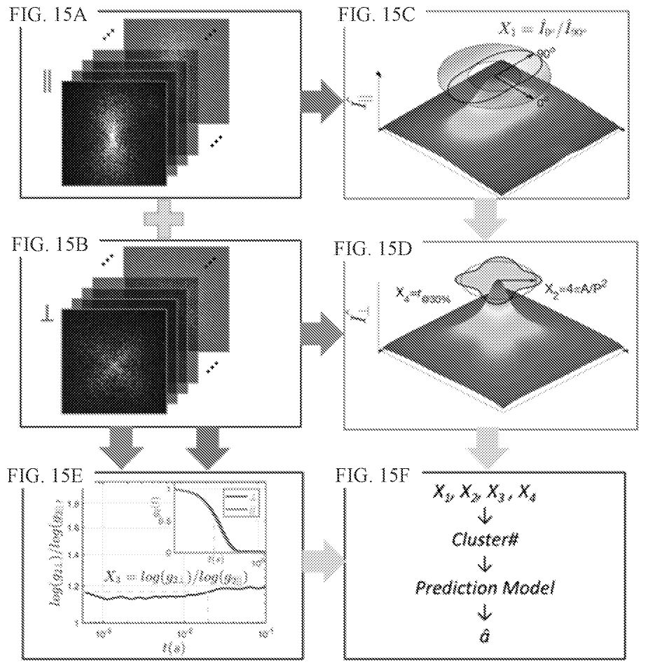

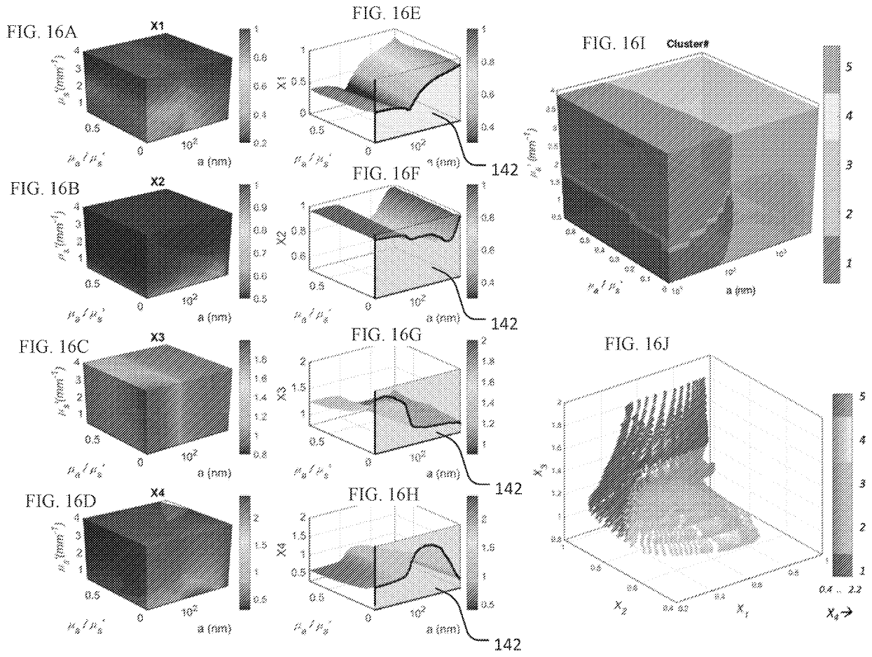

FIG. 16 illustrates a synthetic library of size-dependent attributes, created by a Polarized CT-MCRT. FIGS. 16A-D show volume plots of X1, X2, X3, X4, variations by the particle size, α, reduced scattering coefficient μₛ′, and the normalized absorption coefficient, μₐ/μₛ′. FIGS. 16E-H show cross-sections of the volume plots displaying X₁, X₂, X₃, X₄ for a typical μₛ′=1 mm⁻¹, displaying the variations of the predictors with the particle size, and absorption. The wall plot 142 corresponds to μₛ′=1 mm⁻¹ and μₐ=0. It is evident that X₁ decreases with a in the 10-100 nm range, but follows an opposite trend in the 125 nm to 6 μm range. On the other hand, X2 presents a dip at the sizes closer to the laser wavelength.

X₃ presents a monotonically decaying trend in a, whereas X₄ resembles an inverted U shape, almost reverse of X₂, with a pick that is slightly shifted towards smaller sizes, compared to the valley in X₂ curve. It is evident that the size-dependent variations of X₁, X₂, X₃, X₄ are reduced by absorption. FIG. 16I shows clustering analysis of [X₁,X₂,X₃, X₄] attributes partitions the [a, μₐ, μₛ′] space to 5 distinct clusters. FIG. 16J shows a scatter plot of the cluster assignments in the [X₁,X₂,X₃, X₄] space. The 3 axes of the plot correspond to X₁, X₂, and X₃, while X₄ is depicted by varying the luminescence of the cluster color. A tailored regression model that formulates a as a function of X₁, X₂, X₃, X₄ is obtained for each cluster.

It should be noted that the first approach, captured in eqn. 16 is based on estimating the μₛ′ and assigning the 3-tupled [X1, X2, X3] vector to either the small or larger cluster. On the other hand, the SPARSE approach does not require estimating the μₛ′ as an intermediate step, and is based on assigning the 4-tupled [X1, X2, X3, X4] vector to one of the 5 clusters. Moreover, both the clusters used in the first and second approach and the corresponding regression models are different, as detailed below.

### Development of the SPARSE Prediction Algorithm

We noted that the small and large particles exhibit different dependencies on [X1, X2, X3, X4]. For instance, while in turbid media of smaller size scales and weak scattering, a is an inversely linear function of X1, at larger size scales and rich scattering, the relationship is a direct and exponential. The complexity and non-linearity of the forward mapping between [a, μs′, μa/μs′] and [X1, X2, X3, X4] call for multiple prediction models for different size scales and turbidity levels. To identify the boundaries of these regions, we performed K-mean clustering which partitioned the simulated [X1, X2, X3, X4] pace into 5 mutually exclusive clusters, each of which corresponded to a different region in the [a, μs′, μa/μs′] space. Table S2 lists the cluster centroids.

TABLE S2
Cluster centroids

| Cluster# | X₁ | X₂ | X₃ | X₄ |
|---|---|---|---|---|
| 1 | 0.43 | 0.94 | 1.36 | 0.79 |
| 2 | 0.61 | 0.71 | 1.05 | 1.85 |
| 3 | 0.68 | 0.84 | 1.05 | 1.08 |
| 4 | 0.89 | 0.99 | 1.06 | 0.58 |
| 5 | 0.84 | 1.0 | 1.53 | 0.52 |

Subsequently, a step-wise regression model was used to obtain a prediction model of the particle size for each cluster. While the regression model was linear for cluster #1, i.e. less turbid media of small particle size, it was exponential for the remaining 4 clusters. The predictions models are listed below:

TABLE S3
Regression models correspond to clusters 1-5. The coefficients corresponding
to individual attributes and the interaction terms are listed.

| Cluster# | Intercept | X₁ | X₂ | X₃ | X₄ | X₁ × X₂ | X₁ × X₃ | X₁ × X₄ | X₂ × X₃ | X₂ × X₄ | X₃ × X₄ |
|---|---|---|---|---|---|---|---|---|---|---|---|
| 1 | 439.69 | 0 | 0 | −254.97 | 0 | 0 | 0 | 0 | 0 | 0 | 0 |
| 2 | 3.65 | 0.97 | −1.85 | 0 | −0.95 | 0 | 0 | 0.60 | 0 | 0.64 | 0 |
| 3 | 6.52 | 0.65 | −6.27 | 0 | −2.18 | 2.73 | 0 | −0.44 | 0 | 2.53 | 0 |
| 4 | −182.73 | 108.45 | 151.58 | 132.09 | 14.05 | −83.30 | −13.73 | −15.46 | −107.67 | 31.48 | −31.95 |
| 5 | 126.28 | −119.87 | −123.62 | −2.29 | −89.99 | 120.07 | 0 | 0 | 0 | 94.05 | 0 |

The above table indicates that different predictor attributes and their interactions are distinctly represented in the prediction models corresponding to different clusters. Therefore, while all 4 predictor attributes are involved in identifying the cluster #, they are different weighted in the prediction models.

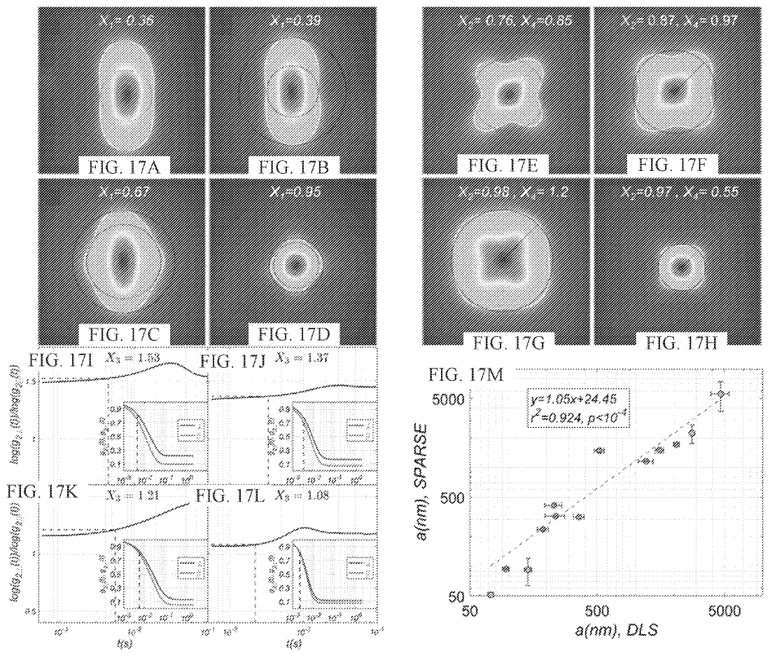

In one example, we evaluated mono-disperse polystyrene microsphere suspensions in aqueous glycerol solutions to assess the ability of SPARSE to measure a in the 75 nm to 5 μm range, as illustrated in FIG. 17. The refractive indices for the microspheres and glycerol solution are np=1.59 and nt≈1.45, respectively, resulting in an index mismatch of np/nt =1.1, which falls within the biologically relevant range. It also matched the value used to develop the SPARSE prediction algorithm, making the approach amenable to these phantoms.

FIG. 17 depicts Î_{∥}, Î_{⊥}, g2∥(t), and g2⊥(t) for polystyrene microsphere phantoms with a of 75 nm, 100 nm, 250 nm, and 5 μm, exhibiting μₛ′ of 0.77, 1.08, 0.97, and 0.63 mm⁻¹, respectively. As a increases, X1 increases from 0.36 to 0.95, while X2 shows less variation at these selected sizes, except for the lower value at 75 nm. X3 and X4 exhibit the expected monotonically decreasing and concave trends, respectively. Minor deviations of these attributes from the curves in FIG. 16 are likely due to variations in μₛ′.

FIGS. 17A-D show Î_{∥} corresponding to aqueous glycerol suspensions of polystyrene microspheres exhibiting radii of 75 nm, 100 nm, 250 nm, and 5000 nm, respectively. Also displayed in each panel is the contour of Î_{∥} at 30% of its maximum together with the calculated X1 values. FIGS. 17E-G show corresponding Î_{⊥} of polystyrene microsphere phantoms. Similarly, the contour at 30% is traced and the calculated X2 and X4 are displayed. FIGS. 17I-L show a ratio of the speckle decorrelation rate in perpendicular and parallel polarization, defined as log (g2⊥(t))/log (g2II(t)). The inset displays g2⊥(t) in red and g2II(t) in blue. X3 is calculated at the temporal point where the g2(t) slope is maximized. FIG. 17M shows a scatter diagram of a, which, as predicted by SPARSE, exhibits a strong, statistically significant correlation with standard DLS measurements.

Based on an extensive observation library, SPARSE prediction algorithm holds the promise to estimate a regardless of μₛ′ variations. When applied to experimentally determined [X1, X2, X3, X4] attributes of polystyrene bead phantoms, the SPARSE prediction algorithm yields values that correlate significantly with DLS measurements (r=0.92, p<10⁻⁴) across the whole range. Additionally, the deviation from the identity curve is only 24 nm. In the following sections, we will demonstrate that despite the fixed index mismatch, the SPARSE method can be applied to a wide range of biological samples to uncover the size scales of granularities in biological tissues with unknown refractive index variations.

### Characterizing the Size Scales of Milk Specimens of Varying Fat Content.

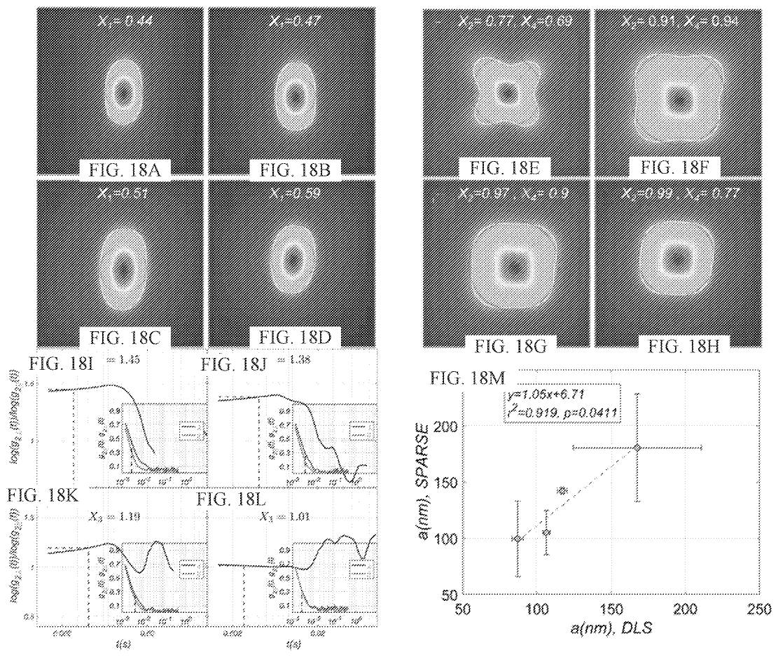

Particle sizing of milk is an integral part of quality control in the dairy industry. It has been reported that in homogenized milk, proteins like casein micelles exhibit typical radii of 100 nm, while fat globules span the 200 nm to 2 μm range. We validated the utility of SPARSE for particle sizing in commercially available non-fat (0%), low-fat (1%), reduced-fat (2%), and whole milk (4%), with unknown refractive index variations. Our measurements indicate that by increasing fat content from 0% to 4%, X1 increases from 0.44 to 0.59, X2 increases from 0.77 to 0.99, and X₃ consistently decreases from 1.45 to 1.01. X4 exhibits a concave trend with fat content (FIG. 18).

FIG. 18 illustrates exemplary characterizations of lipid droplet size in milk. FIG. 18A shows Î_{∥} of non-fat milk, FIG. 18B shows low-fat (1%), FIG. 18C shows reduced-fat (2%), and FIG. 18D shows whole (4%) milk. Also displayed in each panel is the contour of Î_{∥} at 30% of its maximum together with the calculated X1 values. FIGS. 18E-G show corresponding Î_{⊥} of milk. Similarly, the contour at 30% is traced and the calculated X2 and X4 are displayed. FIGS. 18I-L show a ratio of the speckle decorrelation rate in perpendicular and parallel polarization, defined as log (g2⊥(t))/log (g2II(t)). The inset displays g2⊥(t) in red and g2II(t) in blue. X3 is calculated at the temporal point where the g2(t) slope is maximized. FIG. 18M shows a scatter diagram of a, predicted by SPARSE exhibits a strong, statistically significant correlation with standard DLS measurements.

Based on these attributes, SPARSE estimates average particle sizes of 99.6, 105, 142, and 180 nm for 0%, 1%, 2%, and 4% milk samples, which strongly and significantly correlate with DLS measurements. These estimates also align with the expected trend based on the proportions of protein micelles and fat globules. The reported values for the refractive indices of fat globules (nf=1.46, nf/nt=1.1) and protein micelles (np=1.57, np/nt=1.18) are either comparable or higher than those for polystyrene microsphere phantoms. Nevertheless, SPARSE's prediction algorithm remains applicable to these biologically relevant samples.

### Tracing the Shrinkage of RBC Size in Whole Blood Samples of Increased Tonicity

Sizing red blood cells (RBCs) is essential for diagnosing conditions like anemia and age-related degenerative disorders. In this example, we demonstrate SPARSE's capability to evaluate RBC size in fresh whole-blood samples. We obtained blood from a healthy donor and modified its tonicity by spiking it with saline of 0.9% to 20% of NaCl concentrations.

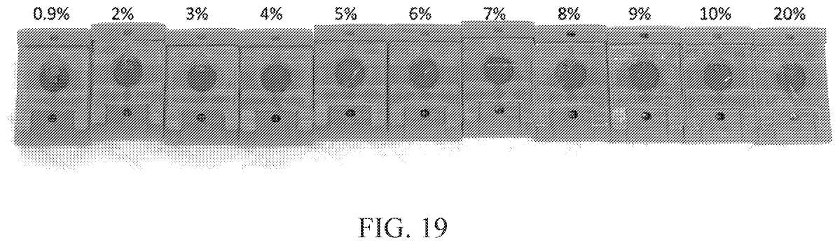

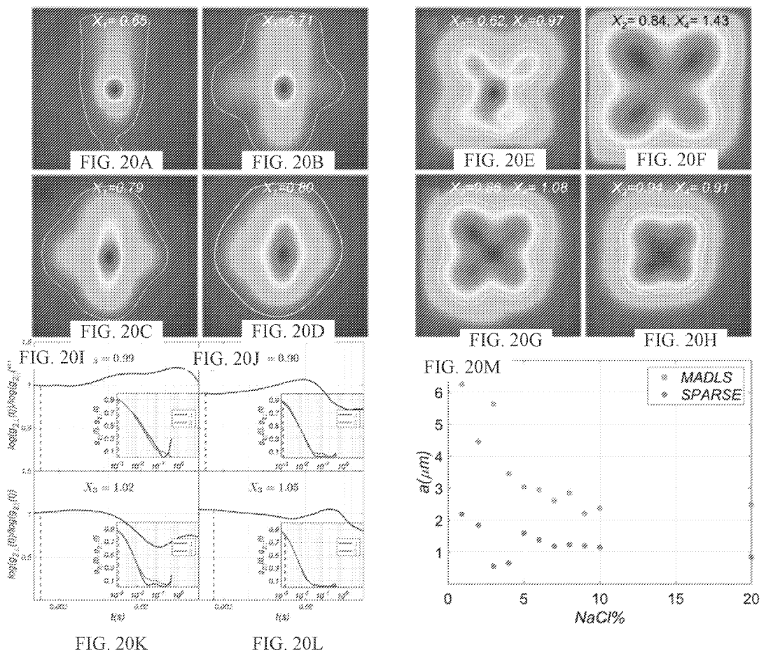

FIG. 19 shows whole blood specimens spiked with saline solutions of different solute concentrations. As the salt concentration increases, the red color becomes increasingly brighter and more vibrant, indicating reduced absorption and increased scattering.

Increased osmolarity causes RBC shrinkage, leading to conformational changes in RBC heme groups, altered absorption spectra, and reduced μa at the illumination wavelength. Higher RBC density enhances the refractive index, thereby increasing μₛ′. Consequently, upon visual inspection, samples with higher NaCl concentration exhibited an obviously brighter red hues. This serves as an ideal model for SPARSE to track size changes in biological particles under unknown optical variations.

The Î_{∥} of isotonic blood is elliptical, exhibiting X1=0.65, which is lower compared to polystyrene phantoms of comparable radii (2.78 μm), likely because of significant μa=0.3 mm⁻¹ of blood at 633 nm. As saline concentration increases, secondary lobes of Î_{∥} begin to appear and X1 raises to 0.8, likely due to reduced pa and enhanced μs′, irrespective of reduced RBC size. This is corroborated by Î_{⊥}, X2 and X4 trends, which reveal μa reduction prior to μₛ′ enhancement. Specifically, a small increase in tonicity expands the Î_{⊥} and makes it more circular because longer optical paths that once were absorbed are now emerging at peripheral regions. Also, in contrast to what is observed in polystyrene phantoms and milk, Î_{⊥} is maximized in the middle of lobes (i.e. petals) rather than the center, because of the lower refractive index mismatch of whole blood (nRBC=1.402, nplasma=1.36, nRBC/nplasma=1.03). With higher tonicity, RBCs contract and become denser, causing Î_{⊥} to shrink, shifting its maxima toward the center, increasing X2, and reducing X4. As expected, X3 remains close to unity, yet both g2∥(t), and g2⊥(t) decay faster at higher NaCl concentrations, reflecting a combination of size reduction, reduced absorption, and enhanced scattering.

We investigate SPARSE's ability to estimate RBC size in the presence of optical property variations compared to standard DLS. Both SPARSE and DLS track RBC shrinkage, but SPARSE's absolute values align more closely with expectations. However, SPARSE may fail to estimate size accurately at 3% and 4% NaCl concentrations, where absorption is nearly eliminated but the refractive index mismatch is significantly lower (1.03) than in the SPARSE prediction algorithm. This is because the resulting high X4 values correspond to much smaller sizes in the SPARSE library. In the future, improving the prediction algorithm's robustness may involve expanding the SPARSE library and introducing additional attributes.

FIG. 20 shows exemplary tracing of RBC shrinkage in response to increased saline concentration of plasma. FIG. 20 shows Î_{∥} of whole blood samples spiked with saline solution of 2% (FIG. 20A), 5% (FIG. 20B), 7% (FIG. 20C), and 10% (FIG. 20D) NaCl concentration, respectively. Also displayed in each panel is the contour of Î_{∥} at 30% of its maximum together with the calculated X1 values. FIGS. 20E-G show corresponding Î_{⊥} of whole blood samples. Similarly, the contour at 30% is traced and the calculated X2 and X4 are displayed. FIGS. 20I-L show ratios of the speckle decorrelation rate in perpendicular and parallel polarization, defined as log (g2⊥(t))/log (g2II(t)). The inset displays g2⊥(t) in red and g2II(t) in blue. X3 is calculated at the temporal point where the g2(t) slope is maximized. m Scatter diagram of a, predicted by SPARSE exhibits a strong, statistically significant correlation with standard DLS measurements.

### Mapping the Particle Size in Heterogenous and Polydisperse Microenvironment of Benign and Carcinoma Bearing Breast Tissues

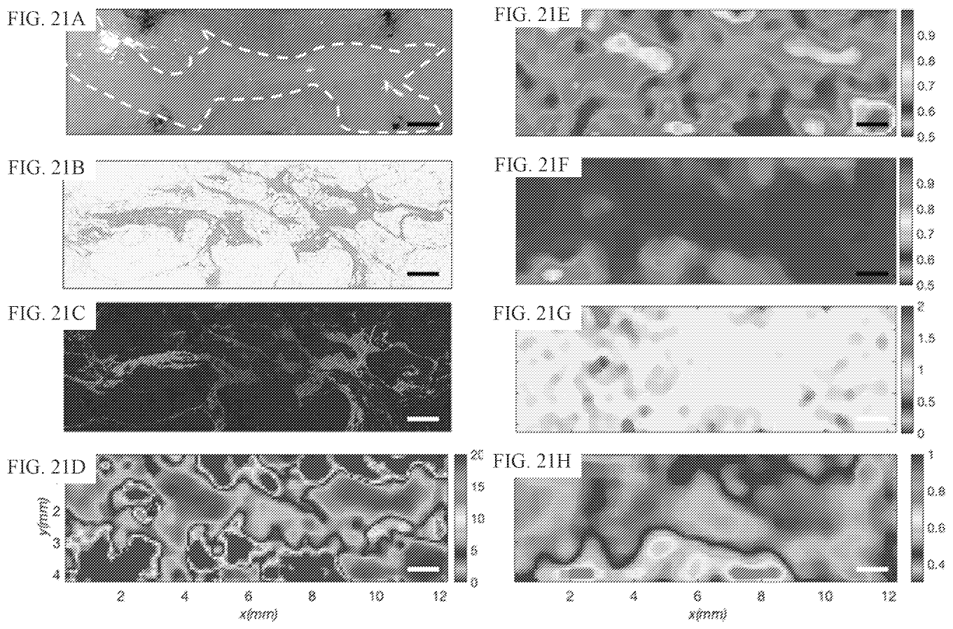

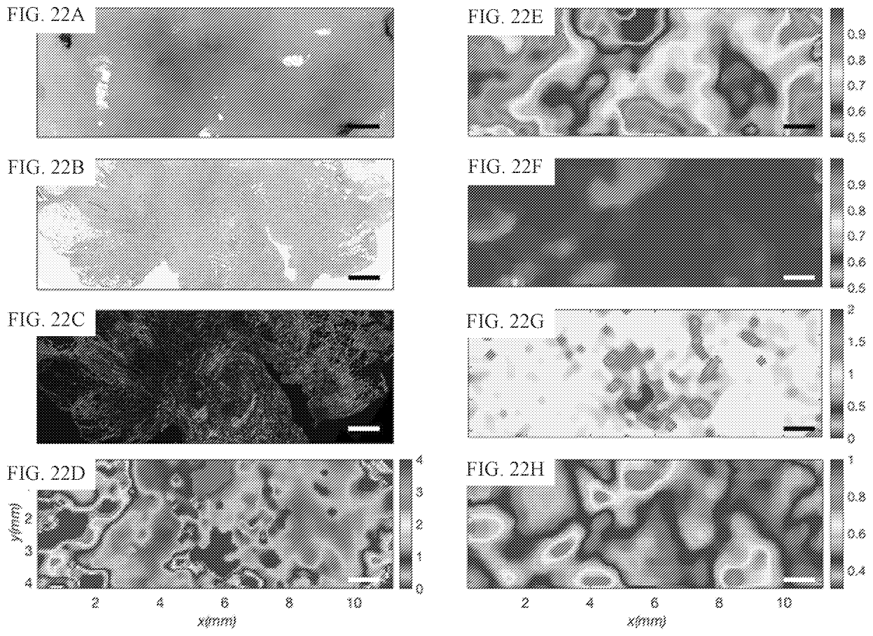

Our results in polystyrene microbeads, milk, and whole blood thus far demonstrate the capability of SPARSE in evaluating the average particle size in homogenous fluid suspensions that exhibit a range of index mismatches and particle concentrations, and in turn optical properties. Here, we challenge the SPARSE to characterize the heterogenous breast tissues, by scanning the laser beam across the surface, measuring the local attributes, and mapping the size variations (FIGS. 21 and 22).

Histology of normal fibroadipose breast tissue typically involves a network of wavy collagen fibrils with radii ranging from 25 to 250 nm, interspersed with adipocytes of at least 20 μm radius. FIG. 21 presents the macroscopic image of benign fibro-adipose breast tissue, accompanied by the corresponding Hematoxylin & Eosin (H&E) section, revealing the arrangement of fibrous and adipose compartments within a single section. The picrosirius-red (PSR) section highlights the presence of thin, undulating collagen fibrils. The SPARSE map uncovers smaller structures below 1 μm in fibrous areas, in striking contrast with larger structures exceeding 20 μm, that coincide with adipose regions. Distinguished regions identified within the spatial maps of size-dependent attributes correspond to various tissue compartments. Notably, areas with diminished X1 values align with fibrous tissue in both the H&E and PSR sections.

Conversely, heightened X2 values coincide with fibrous areas in the macroscopic image of the tissue. In contrast, X3 remains nearly constant across the tissue, except for sporadic specks of elevated values that occasionally align with fibrous structures. Lastly, regions of reduced X4 values correspond to the fibrous compartment. While these correlations are evident, their precision is somewhat compromised. This is likely attributable to the depth-integrated nature of SPARSE as opposed to the confined single-plane representation of both gross and fine histopathology. Moreover, the resolution of SPARSE is set by the beam spot size, scanning pitch, and the volume-integrated nature of the measurement, hampering the precise co-registration and causing the fluidity of the agreements.

FIG. 21A shows a photograph displaying the gross pathology of normal fibroadipose tissue. Dashed lines outline the fibrous compartment. FIG. 21B shows the hematoxylin and Eosin (H&E) histology section and highlights the fibrous and adipose regions. FIG. 21C shows the picrosirius red (PSR) and highlights the thin, wavey collagen fibrils. FIG. 21D shows a spatial map of a. Regions of increased particle size correspond to fat globules in breast tissue, whereas areas of reduced size align with fibrous structures. FIG. 21E shows a spatial map of X1 displaying reduction of this attribute at the regions that correspond with fibrous tissue in the H&E and PSR section. FIG. 21F shows a spatial map of X2 exhibiting slightly higher values in the fibrous areas. FIG. 21G shows a spatial map of X3 that is nearly 1 across the tissue except for isolated specks of higher values that occasionally coincide with fibrous structures. FIG. 21H shows a spatial map of X4 showing reduction and an attribute in the fibrous regions. Overall, the distinct regions outlined in X1, X2, and X4 agree with the borders of tissue compartments. Scale bas are 1 mm.

To validate SPARSE in a more complex setting, we also evaluate an invasive ductal carcinoma breast tissue (FIG. 22). The intermediate-grade tumor cells invade in a trabecular pattern into the peripheral adipose tissue, as evidenced by the coregistered H&E image. PSR section reveals the desmoplastic stroma in the background. In the middle, the tissue features a necrotic area devoid of cells that over time has transformed into scar tissue comprised of denatured collagen debris enclosed by thick collagen fiber bundles. The SPARSE map highlights the larger particle size in the peripheral adipose region. The core fibro-glandular areas are dominated by smaller particles. In particular, the scarred area, which presents clefting of collagen debris, elicits sizes below 100 nm. This area is encircled by a few isolated islands of larger size scales that loosely coincide with bundled collagen fibers. A significant drop in the particle size is also observed in other areas of collagen breakdown.

Overall, compared to normal fibrous tissue, invasive ductal carcinoma presents a greater deal of size heterogeneity, which varies according to the histological features. Since malignant cell nuclei are reported to be larger than 6 μm, we expected to observe larger sizes in the tumor epithelium. However, because of the volume-integrated nature of SPARSE, other smaller structural elements likely dominate the scattering signal, eliciting only the average scattering particle size within the illuminated volume. In the future, using a smaller beam spot and smaller scanning steps could likely increase the resolution and contrast of SPARSE measurements to permit isolating nuclear features from other organelles, membranes, and collagen fibrils. As before, the spatial maps of X1, X2, X3, and X4 mirror the tissue histopathology.

Interestingly, X1 is higher in fibrous and adipose regions, and lower in tumor epithelium. On the other hand, X2 is minimized in the purely epithelial regions but presents higher values even in the subtle presence of stromal components in the PSR image. As before, X3 remains nearly constant across the tissue, except for a few specks that, in the case of tumor tissue, correspond to the fissures in the collagen meshwork. Lastly, X4 variations are the exact opposite of X2 in the epithelial and stromal regions. It is to be noted that the SPARSE prediction algorithm that provides the mapping between X1, X2, X3, and X4 and the particle size is developed in the context of mono-dispersed homogenous turbid media. In a highly complex heterogeneous microenvironment, such as breast carcinoma, tissue polydispersity modulates the photon path length distributions, with small and large particles being further represented in the co- and cross-polarized speckle, respectively. As such, X1, X2, X3, and X4 may elicit additional implications due to tissue polydispersity. Developing more sophisticated prediction models could improve the accuracy of SPARSE measurements.

FIG. 22 shows particle size distribution in an invasive breast carcinoma microenvironment. FIG. 22A shows a photograph that displays the gross pathology of a human breast carcinoma tissue specimens. FIG. 22B shows the matching hematoxylin and Eosin (H&E) histology section that entails the infiltrating tumor cells interspersed with stromal fibers taking up most of the tissue fragment, featuring a necrotic, scarred tissue in the middle. In the peripheral areas, the tumor is invading the fibro adipose structures. FIG. 22C shows PSR section. FIG. 22D is a spatial map of a. Regions of increased particle size correspond to fat globules in the periphery. The size is generally lower within invasive components except by a few regions that correspond to very thick bright red collagen bundles. Necrosed and scarred areas exhibit the lowest size values. FIG. 12E is a spatial map of X1 displaying reduction of this attribute within invasive areas that are populated by tumor cells and denatured collagen and are devoid of adipose and thick fibers. FIG. 22G is a spatial map of X2 exhibiting lower values in cellular areas. FIG. 22G is a spatial map of X3 is nearly 1 except for hollow areas in the PSR section. FIG. 22H is a spatial map of X4 showing reduction of this attribute in the fibrous regions. Scale bas are 1 mm.

### Additional Systems and Methods of Particle Sizing

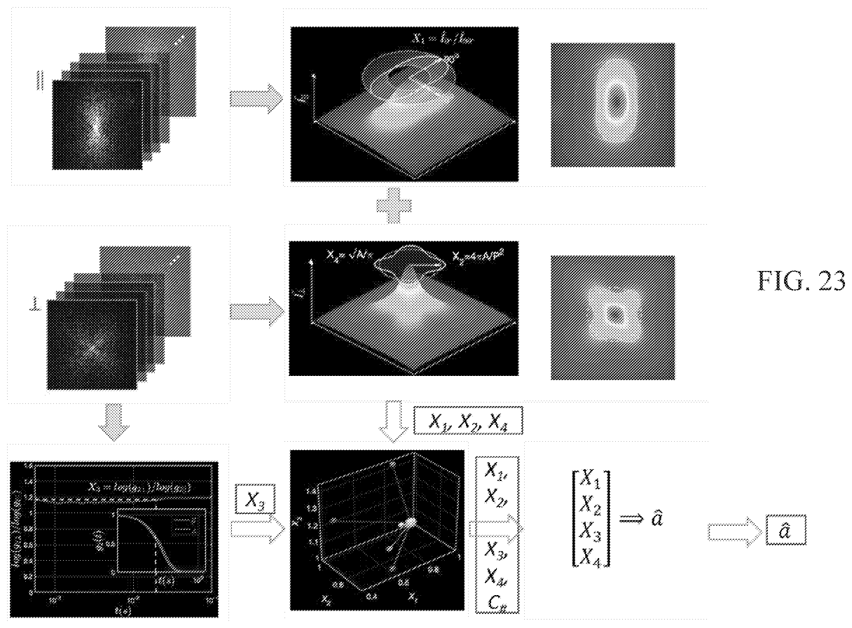

FIG. 23 illustrates an exemplary workflow development of a model that can be used to predict the scattering of particle size from polarization-dependent attributes of laser speckle. The workflow includes first obtaining parallel and perpendicular polarized speckle patterns. Next, temporal averaging of the speckle patterns yields the DRP∥ and DRP⊥ from which X1, X2, and μs′ are extracted. Next, the cluster centroids and the prediction model are determined based on the μₛ′. In addition, temporal cross-correlation analysis of speckle frames provides the g2⊥(t) and g2∥(t), from which X3 is evaluated as X3=log (g2⊥(t))/log (g2∥(t)). Finally, X1-X3 are plugged into the prediction model to obtain the a. It should be appreciated that a variety of polarized speckle patterns can be used. For example, the second polarized speckle pattern should be 90° offset from (i.e., orthogonal to) the first polarized speckle pattern.

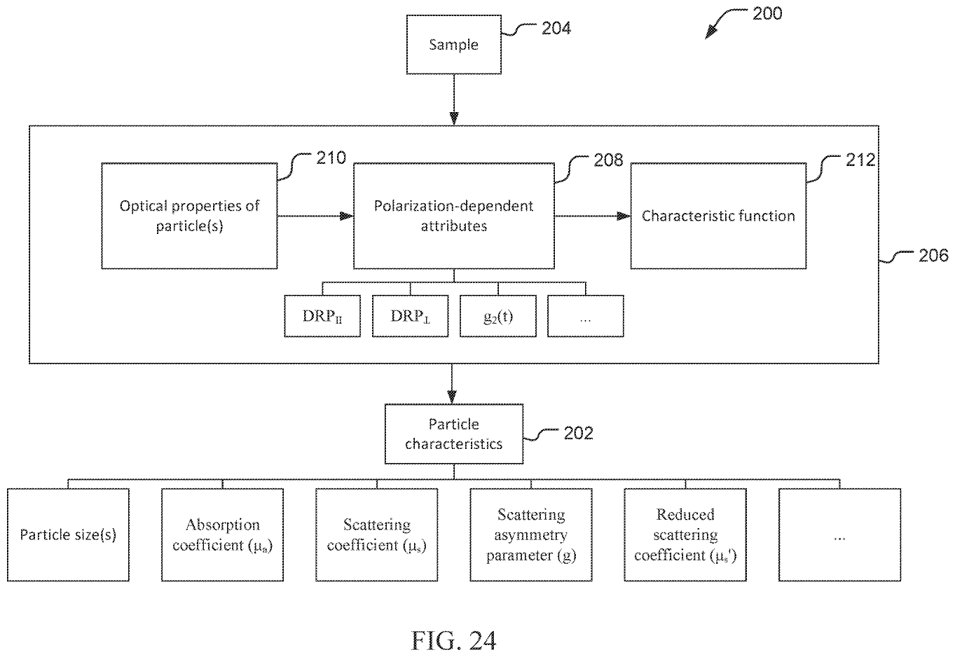

FIG. 24 illustrates a schematic diagram of an exemplary system 200 for determining one or more particle characteristics 202 of a sample 204. The particle characteristics 202, for example, can include one or more particle size(s), an absorption coefficient, a scattering coefficient, a scattering asymmetry parameter, and/or a reduced scattering coefficient. It should be appreciated that the system 200 can output one or more of these characteristics, among others.

The system 200 includes a processor 206. The processor 206 can be configured to extract one or more attributes (e.g., polarization attributes) 208 from the sample 204. The attributes 208 can correlate to one or more optical properties 210 of the sample 204. The system 200 can be used with the systems and methods described above. For example, an optical setup with a light source and a camera can be configured to acquire backscattered light from the sample 204 to form a speckle pattern. The speckle pattern of the sample 204 can then be sent to the processor 206 where the optical properties of the speckle pattern can be analyzed and the attributes 208 can be extracted. As described herein, polarization-dependent attributes can include a parallel-polarized diffuse reflectance profile, a perpendicularly-polarized diffuse reflectance profile, and/or a speckle intensity autocorrelation function, among others. These attributes can then be passed through a model or function that characterizes the attributes and outputs one or more particle characteristics 202.

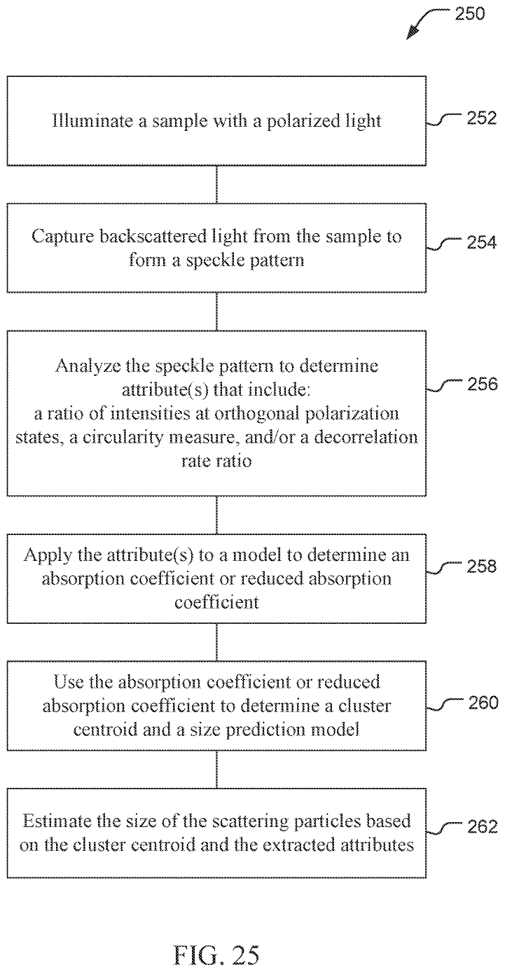

FIG. 25 illustrates a method 250 for determining one or more sizes of scattering particles in a sample. At block 252, the method 250 includes illuminating a sample with a polarized light. At block 254, the method 250 includes capturing backscattered light from the sample to form speckle pattern. At block 256, the method 250 includes analyzing the speck pattern to determine one or more attributes. At block 258, the method 250 includes applying the one or more attributes to a model or a function to determine a coefficient, such as an absorption coefficient or a reduced absorption coefficient. At block 260, the method 250 includes using the coefficient to determine a cluster centroid and a size prediction model. At block 262, the method 250 includes estimating the size of the scattering particles based on the cluster centroid and the extracted attributes.

Further, it should be appreciated that varying components of particle sizing systems and methods described herein can be interchanged with various systems and methods from other embodiments. Thus, components of the various examples described herein should not be limited to the individual example, and can be incorporated into other embodiments.

As used herein, unless otherwise specified or limited, the terms “mounted,” “connected,” “supported,” “secured,” and “coupled” and variations thereof, as used with reference to physical connections, are used broadly and encompass both direct and indirect mountings, connections, supports, and couplings. Further, unless otherwise specified or limited, “connected,” “attached,” or “coupled” are not restricted to physical or mechanical connections, attachments or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

In some embodiments, aspects of the invention, including computerized implementations of methods according to the invention, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the invention can be implemented as a set of instructions, tangibly embodied on a non-transitory computer-readable media, such that a processor device can implement the instructions based upon reading the instructions from the computer-readable media. Some embodiments of the invention can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some embodiments, a control device can include a centralized hub controller that receives, processes and (re) transmits control signals and other data to and from other distributed control devices (e.g., an engine controller, an implement controller, a drive controller, etc.), including as part of a hub-and-spoke architecture or otherwise.

As used herein in the context of computer implementation, unless otherwise specified or limited, the terms “component,” “system,” “module,” “block,” “device,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Also as used herein, unless otherwise limited or defined, “configured to” indicates that a component, system, or module is particularly adapted for the associated functionality. Thus, for example, an NN configured to MM is specifically adapted to MM, as opposed to merely being generally capable of doing so.

In some implementations, devices or systems disclosed herein can be utilized, manufactured, installed, etc. using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto.

Various features and advantages of the invention are set forth in the following claims.

1. A system for determining a size of scattering particles in a sample, the system comprising:
a light source configured to illuminate the sample with polarized light;
a camera configured to acquire backscattered light from the sample to form a speckle pattern; and
a processor configured to:
extract polarization-dependent attributes of the speckle pattern from two orthogonal polarization states that correlate to a size of the scattering particles and optical properties of a medium of the sample;
subject the polarization-dependent attributes to a function to determine the size of the scattering particles; and
generate a report indicating the size of the scattering particles in the sample.

2. The system of claim 1, wherein the polarized light includes both parallel-polarized light and perpendicular-polarized light.

3. The system of claim 1, wherein the polarization-dependent attributes are derived from a parallel-polarized diffuse reflectance profile, a perpendicularly-polarized diffuse reflectance profile, or a speckle intensity autocorrelation function associated with both parallel-polarized light and perpendicular-polarized light.

4. The system of claim 1, wherein the report further includes at least one of an absorption coefficient (μₐ), a scattering coefficient (μₛ), a scattering asymmetry parameter (g) of the scattering particles, or a reduced scattering coefficient (μₛ′), given by μₛ(1-g).

5. The system of claim 1, wherein the sample includes multiple particles of multiple sizes and processor is further configured to determine the size of multiple particles of multiple sizes and generate the report indicating sizes determined of the multiple particles of multiple sizes.

6. The system of claim 1, wherein the function includes multiple regression models corresponding to different particles or particle sizes.

7. The system of claim 1, wherein the size of the scattering particles is between sizing to 10 nm-6 μm.

8. The system of claim 1, wherein the particle includes a synthetic polymer, a tumor, a platelet, or a particle in whole blood.

9. The system of claim 1, wherein the sample is a turbid biological material.

10. A method for determining a size of scattering particles in a sample comprising:
illuminating the sample with a polarized light;
capturing backscattered light from the sample to form a speckle pattern;
analyzing the speckle pattern to determine attributes that include at least one of a ratio of intensities at orthogonal polarization states, a circularity measure, or a decorrelation rate ratio of speckle intensity modulations at parallel and orthogonal polarization states;
applying the attributes to a model to determine an absorption coefficient or reduced absorption coefficient;
using the absorption coefficient or reduced absorption coefficient to determine a cluster centroid and a size prediction model; and
estimating the size of the scattering particles based on the cluster centroid and the attributes.

11. The method of claim 10, wherein the polarized light includes both parallel-polarized light and perpendicular-polarized light.

12. The method of claim 10, wherein the ratio of intensities at parallel polarization states is a ratio of parallel polarized diffuse reflectance, at 90 to 0 degrees azimuth angles.

13. The method of claim 10, wherein the circularity of the intensity envelope is a diffuse reflectance profile of backscattered light from perpendicular-polarized light.

14. The method of claim 10, wherein the decorrelation rate ratio is a log ratio of a temporal intensity autocorrelation function for parallel-polarized light and perpendicular-polarized light.

15. The method of claim 10, further comprising determining at least one of an absorption coefficient (μₐ), a scattering coefficient (μₛ), a scattering asymmetry parameter (g), or a reduced scattering coefficient (μₛ′), given by μₛ(1-g).

16. The method of claim 10, wherein an average size of the scattering particle in a medium of the sample is between sizing to 10 nm-6 μm.

17. The method of claim 10, wherein the particle includes a synthetic polymer, a lipid, a biological tissue, a cell, a platelet, or a particle in whole blood.

18. The method of claim 10, wherein the sample is a turbid biological material.

19. A system for determining a size of scattering particles in a sample, the system comprising:
a light source configured to emit a polarized light beam;
a sample stage for positioning the sample in a path of the polarized light beam;
at least one camera positioned to capture backscattered light from the sample and form a speckle pattern; and
a processing unit configured to:
analyze polarization-dependent attributes of the speckle pattern to extract a set of attributes from the speckle pattern that include at least one of a ratio of intensities along a short and long axis of parallel polarized back-scattered light, a circularity of an intensity envelope at orthogonal polarization states, a decorrelation rate ratio, or a radial extend of the intensity envelope;
use an absorption coefficient or reduced absorption coefficient to determine a centroid coordinates and a size prediction model; and
estimate the size of the scattering particles based on a cluster centroid and the extracted attributes.

20. The system of claim 19, wherein the light source is a laser configured to emit linearly polarized light.

21. The system of claim 19, further comprising a polarization analyzer configured to switch between at least two orthogonal polarization states to capture the speckle patterns.

22. The system of claim 19, wherein the sample stage is motorized to scan the sample in at least one dimension.

23. The system of claim 19, wherein the processing unit includes a memory storing a database of the centroid coordinates corresponding to known particle sizes.

24. The system of claim 19, wherein the processing unit is further configured to perform temporal averaging of the speckle patterns to derive the polarization-dependent attributes.

25. The system of claim 19, wherein the camera is configured to capture the speckle pattern at a frame rate that is synchronized with dynamics of the sample.

26. A method for determining the size of scattering particles in a sample comprising:
illuminating the sample with a polarized light;
capturing backscattered light from the sample to form a speckle pattern;
analyzing the speckle pattern to determine attributes that include at least one of a ratio of intensities along the long and short axes of intensity envelope at the parallel polarization state, a circularity of the intensity envelope at orthogonal polarization states, a decorrelation rate ratio of speckle intensity modulations at parallel and orthogonal polarization states, or a radial extent of the intensity envelope at orthogonal polarization states;
applying the attributes to a clustering approach that assigns the four-tupled attribute vector to one of five clusters; and
estimating the size of the particles based on a regression model of the said cluster, without the need to estimate or know the optical properties.
